(19) United States
(12) Patent Application Publication
(10) Pub. No.: US 2022/0212158 A1
(43) Pub. Date: Jul. 7, 2022

(54) Systems For Producing Chemicals And Fuels Having An Optimized Carbon Footprint

(71) Applicant: MAAT Energy Company, Cambridge, MA (US)

(72) Inventors: Kim-Chinh Tran, Cambridge, MA (US); Leslie Bromberg, Sharon, MA (US); Jorj Ian Owen, Dulles, VA (US); Jonathan Whitlow, Melbourne Beach, FL (US)

(21) Appl. No.: 17/609,063

(22) PCT Filed: May 13, 2020
(86) PCT No.: PCT/US2020/032606

§ 371 Date: Nov. 5, 2021

Related U.S. Application Data
(60) Provisional application No. 62/847,986, filed on May 15, 2019.

(51) Int. Cl. B01J 19/24; C01B 3/34; C01C 1/04; C25B 1/04; B01D 53/18; C25B 15/08

(52) U.S. Cl. CPC B01J 19/2445; B01D 2252/204; C01C 1/0494; B01J 19/2465; C25B 1/04; B01D 53/18; C25B 15/081; C01B 2203/0233; C01B 2203/0283; C01B 2203/04; C01B 2203/062; C01B 2203/068; C01B 2203/0861; C01B 2203/141; C01B 2203/148; C01B 3/342

(57) ABSTRACT

Chemical production systems which allow for an optimized carbon footprint are presented. Plasma-based reforming systems may provide a viable alternative to standard chemical production techniques, such systems can reduce the carbon footprint of the chemicals produced. Example systems include the production of synthesis gas (syngas), hydrogen, synthetic hydrocarbon fuels, ammonia, and urea. Reducing the carbon footprint of chemicals such as these is of vital importance to reducing the environmental impact of industries such as transportation and agriculture. In many of the embodiments a secondary product is produced, the sale of this secondary product may make the primary low-carbon footprint chemical more economical. In many cases the secondary product is carbon, methods of sequestering this carbon via reverse mining and enhanced oil and gas recovery are presented.

### CLAIM OF PRIORITY

This disclosure claims priority to U.S. Provisional Application No. 62/847,986, filed May 15, 2019, the disclosure of which is incorporated by reference in its entirety.

### STATEMENT OF GOVERNMENT-SPONSORED RESEARCH

This invention was made with government support under grant number DE-SC0019791, awarded by the United States Department of Energy, Small Business Innovation Research. The government has certain rights in the invention.

### FIELD OF INVENTION

The present invention relates generally to the creation of chemical producing systems which allow for an optimized carbon footprint. Example systems for the production of synthesis gas (syngas), hydrogen, hydrocarbon fuels, ammonia, and urea are presented. Reducing the carbon footprint of chemicals such as these is of vital importance to reducing the environmental impact of industries such as transportation and agriculture. In many of the embodiments a secondary product is produced, the sale of this secondary product may make the primary low-carbon footprint chemical more economical. In many cases the secondary product is carbon, methods of sequestering this carbon via enhanced oil and gas recovery are presented.

### BACKGROUND OF THE INVENTION

Chemical and fuel production and use are major sources of greenhouse gases in the earth's atmosphere and are contributing to climate change. Additionally, fossil-fuel sources are becoming scarcer and more difficult to recover. In order to reduce the emission of greenhouse gases, slow climate change, and maintain lifestyle standards in transportation and agriculture, new greener systems for chemical production are of vital importance.

The synthesis of many fuels and chemicals starts with the formation of hydrogen or syngas (a mixture of hydrogen and carbon monoxide). The production of these gases is currently dominated by steam-methane reforming, where water (H2O) and methane (CH4) are converted with catalytic assistance into hydrogen (H2) and carbon monoxide (CO) where there are about three hydrogen molecules for every carbon monoxide molecule (H2O+CH4→CO+3*H2). This reaction is highly endothermic, requiring 225.4 kJ/mol from room temperature, the thermal energy required is typically provided by combusting natural gas (primarily CH4), which produces carbon dioxide.

For chemical processes requiring hydrogen, the carbon monoxide molecule is generally “shifted” to additional hydrogen using the water-gas shift reaction. Water is added to the carbon monoxide-rich gas and carbon dioxide and hydrogen gas form (CO+H2O→CO2+H2). This reaction is slightly exothermic releasing 41.0 kJ/mol. Thus, the production of hydrogen gas produces additional carbon dioxide.

Green alternatives for producing hydrogen exist, such as electrolysis. However, since all of the energy for electrolysis must be provided by electricity the operational costs may be prohibitive for such systems alone.

### SUMMARY OF THE INVENTION

Plasma-based reforming systems may provide a viable alternative to the standard steam-methane reforming methods which produce greenhouse gases, and electrolysis only methods which uses only electrical energy sources.

Plasma-based reforming systems can be used to do the aforementioned steam reforming where water and methane are used to make syngas, however instead of combusting methane or other hydrocarbons to provide the energy to drive the reaction the energy is provided by an electrically driven plasma. If the electricity source does not produce greenhouse gases, the carbon footprint of plasma-based syngas production is reduced.

Plasma-based reforming can also be applied to other reforming reactions, such as, dry reforming and pyrolysis. In dry reforming carbon dioxide (CO2) and methane (CH4) are converted into hydrogen (H2) and carbon monoxide (CO) where there are about one hydrogen molecules for every carbon monoxide molecule (CO2+CH4→2*C0+2*H2). Like steam reforming, this reaction is highly endothermic, requiring 260.5 kJ/mol from room temperature. To consume additional CO2 reverse water-gas shift reactions (CO2+H2 [symbol] CO+H2O) can be encourage by running CO2-rich, ideally in this case three molecules of CO2 could be reformed with every CH4 molecule (CH4+3*CO2 [symbol] 4*CO+2*H2O).

In methane pyrolysis the methane (CH4) is converted into hydrogen (H2) and carbon (C) where there are about two hydrogen molecules for every carbon atom (CH4→2*H2+C). Methane pyrolysis is also endothermic requiring 74.9 kJ/mol from room temperature. Larger hydrocarbon materials can also be pyrolyzed, the ratio of hydrogen molecules to carbon atoms trend closer to one the longer the hydrocarbon molecule is.

The energy to drive plasma-based reforming systems is electrical energy. When the electricity is generated using means that do not emit greenhouse gases, the production of hydrogen and syngas can have greatly reduced carbon footprints.

Devices and methods for creating plasma-based reforming and pyrolyzing units have previously been disclosed in PCT/US2020/019689, which is incorporated by reference in its entirety. In this disclosure, systems for chemical production that have an optimized carbon footprint by incorporating such plasma-based reforming and/or pyrolyzing units are disclosed.

### BRIEF DESCRIPTION OF THE DRAWINGS

To better illustrate the invention and to aid in a more thorough description which provides other advantages and objectives of the invention the following drawings are referenced. It is noted that these embodiments are specific examples of the invention and not to be understood as limiting cases for the scope of this invention. The drawings are as follows:

FIG. 1: Block diagram of a system for chemical production according to the prior art.

FIG. 2: Block diagram of a system for chemical production with an optimized carbon footprint according to the first embodiment.

FIG. 3: Block diagram of a system for the chemical production of synthetic hydrocarbon products with an optimized carbon footprint according to the first embodiment.

FIG. 4: Block diagram of a system for chemical production with an optimized carbon footprint according to the second embodiment.

FIG. 5: Block diagram of a system for the chemical production of synthetic hydrocarbon products and oxygen with an optimized carbon footprint according to the second embodiment.

FIG. 6: Block diagram of a system for the chemical production of synthetic hydrocarbon products and carbon with an optimized carbon footprint according to the second embodiment.

FIG. 7: Block diagram of a system for the chemical production of ammonia and carbon with an optimized carbon footprint according to the second embodiment.

FIG. 8: Block diagram of a system for chemical production with an optimized carbon footprint according to the third embodiment.

FIG. 9: Block diagram of a system for the chemical production of hydrogen and carbon with an optimized carbon footprint according to the third embodiment.

FIG. 10: Block diagram of a system for chemical production with an optimized carbon footprint according to the fourth embodiment.

FIG. 11: Block diagram of a system for the chemical production of synthetic hydrocarbon products and carbon with an optimized carbon footprint according to the fourth embodiment.

FIG. 12: Block diagram of a system for the chemical production of ammonia and carbon with an optimized carbon footprint according to the fourth embodiment.

FIG. 13: Block diagram of a system for chemical production with an optimized carbon footprint according to the fifth embodiment.

FIG. 14: Block diagram of a system for the chemical production of ammonia, carbon, carbon dioxide, and electricity with an optimized carbon footprint according to the fifth embodiment.

FIG. 15: Block diagram of a first example enhanced oil and gas recovery system using carbon product.

FIG. 16: Block diagram of a second example enhanced oil and gas recovery system using carbon product.

FIG. 17: Block diagram of a third example enhanced oil and gas recovery system using carbon product.

### DETAILED DESCRIPTION OF THE INVENTION:

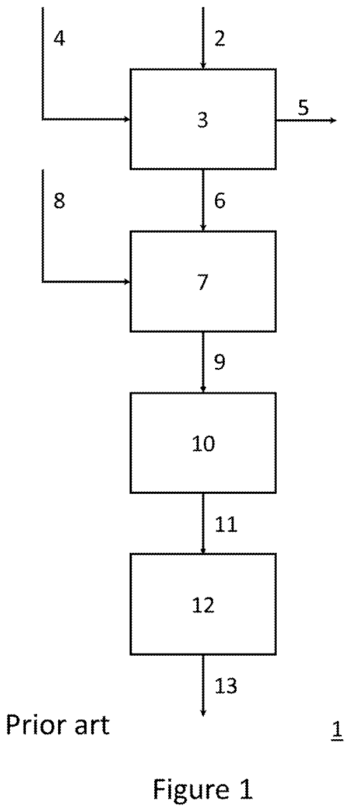

FIG. 1 gives a block diagram of a system for chemical production according to the prior art 1. Reactants 2 are fed into a steam-methane reformer 3. For steam-methane reforming the reactants 2 comprise water in vapor form and methane, generally from a methane-rich source such as natural gas. Methane and air are provided as fuel 4 to drive the reforming reaction, the fuel 4 is separately fed into the steam-methane reformer 3. The fuel 4 generally comes from a methane-rich source, such as natural gas. The methane and air provided as a fuel 4 to drive the reforming reaction is combusted in the steam-methane reformer 3, wherein the combustion produces carbon dioxide 5. The heat generated by combustion drives the reforming of the reactants 2 into an initial product 6 of hydrogen and carbon monoxide.

The initial product 6 flows to a shift reactor 7 where the ratio of hydrogen to carbon monoxide is altered. A shift feedstock 8 is also fed into the shift reactor 7 and a shifted product 9 is formed. If the desired shifted product 9 is hydrogen, the shift feedstock 8 comprises water and the water-gas shift would occur to form additional hydrogen (CO+H2O [symbol] CO2+H2). If the desired shifted product 9 is syngas having a ratio of hydrogen to carbon monoxide less than three the shift feedstock 8 would comprise carbon dioxide and the reverse water-gas shift would occur to form additional carbon monoxide (CO2+H2 [symbol] CO+H2O).

The shifted product 9 flows out of the shift reactor 7 into a gas conditioner 10. Depending on what molecules need to be removed from the shifted product 9 the gas conditioner 10 may take a variety of forms. To remove water from the shifted product 9 the gas conditioner 10 may contain a vapor-liquid separator. To remove carbon dioxide from the shifted product 9 the gas conditioner 10 may contain a carbon dioxide removal system such as amine scrubbing. Other parts of the gas conditioner 10 may include compression, cooling, heating, targeted molecule removal, molecule addition, and additional syngas ratio modification. Conditioned gas 11, such as hydrogen or syngas with a specified hydrogen to carbon monoxide ratio, exit the gas conditioner 10 and enter the processing unit 12. The processing unit uses the conditioned gas 11 to produce a final product 13. The processing unit 12 may be as simple as bottling or depositing the conditioned gas 11 into a pipeline. The processing unit 12 may also include further molecule processing steps such as ammonia, urea, methanol, alcohols, and hydrocarbon formation or oil refining.

As discussed above, replacing steam-methane reformers with plasma-based reformers and pyrolysis units can lead to systems for chemical production that have a reduced carbon footprint. Additionally, the wider range of feedstocks which can be processed in plasma-based reformers, as compared to steam-methane reformers, yield new system configurations for producing chemical products and co-products.

### Embodiment 1

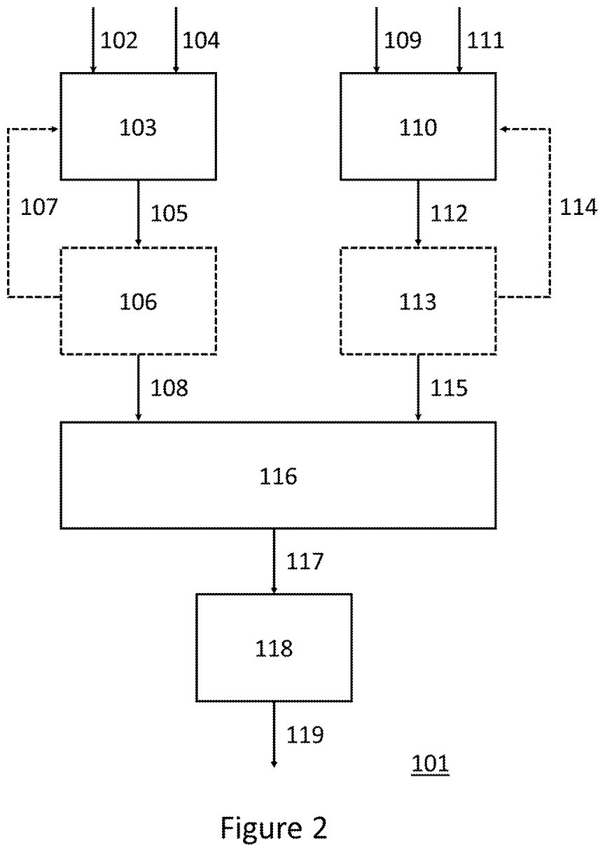

FIG. 2 gives a block diagram of a system for chemical production with an optimized carbon footprint according to the first embodiment 101. First reactants 102 are fed into a first reformer unit 103 along with a first portion of electricity 104. The energy in the first portion of electricity 104 is used to drive the reformation of the first reactants 102 into a first initial product 105. The first reformer unit 103 is configured to use the first portion of electricity 104 to molecularly alter the composition of the first reactants 102.

The first initial product 105 may flow into an optional first initial product conditioner 106. In the optional first initial product conditioner 106 unwanted molecules (such as water, carbon dioxide, sulfur-containing molecules) can be removed and the gases may be compressed, and/or an optional first recycling line 107 may be included to reinject a portion of the gases back into the first reformer unit 103. Gases not recycled to the first reformer unit 103 exit the optional first initial product conditioner 106 as a first conditioned initial product 108. If an optional first initial product conditioner 106 is not included the first initial product 105 and first conditioned initial product 108 are equivalent.

Second reactants 109 are fed into a second reformer unit 110 along with a second portion of electricity 111. The energy in the second portion of electricity 111 is used to drive the reformation of the second reactants 109 into a second initial product 112. The second reformer unit 110 may be configured to use the second portion of electricity 111 to molecularly alter the composition of the second reactants 109.

The second initial product 112 may flow into an optional second initial product conditioner 113. In the optional second initial product conditioner 113 unwanted molecules (such as water, carbon dioxide, sulfur-containing molecules) can be removed and the gases may be compressed, and/or an optional second recycling line 114 may be included to reinject a portion of the gases back into the second reformer unit 110. Gases not recycled to the second reformer unit 110 exit the optional second initial product conditioner 113 as a second conditioned initial product 115. If an optional second initial product conditioner 113 is not included the second initial product 112 and second conditioned initial product 115 are equivalent.

The first conditioned initial product 108 and the second conditioned initial product 115 flow into a conditioner 116. The conditioner 116 alters the properties (composition, temperature, pressure) of the gases to that which is required downstream. The conditioner 116 mixes the first conditioned initial product 108 and the second conditioned initial product 115. The conditioner 116 may also compress the gases, remove unwanted molecules (such as water, carbon dioxide, sulfur-containing molecules), and add additional molecules. The amount of conditioning that must occur in the conditioner 116 depends partly on if the optional first initial product conditioner 106 and the optional second initial product conditioner 113 were included. Although not shown a recycling line could also be included flowing from the conditioner 116 to the first reformer unit 103, the second reformer unit 110, or both reformers. A conditioned intermediate product 117 exits the conditioner 116.

The conditioned intermediate product 117 flows to a processing unit 118 where a final chemical product 119 is formed. The processing unit 118 may be as simple as bottling or depositing the conditioned intermediate product 117 into a pipeline. The processing unit 118 may also include further molecule processing steps such as ammonia, urea, methanol, alcohols, and hydrocarbon formation or oil refining.

### Example of the First Embodiment: a System for the Chemical Production of Synthetic Hydrocarbon Products with an Optimized Carbon Footprint

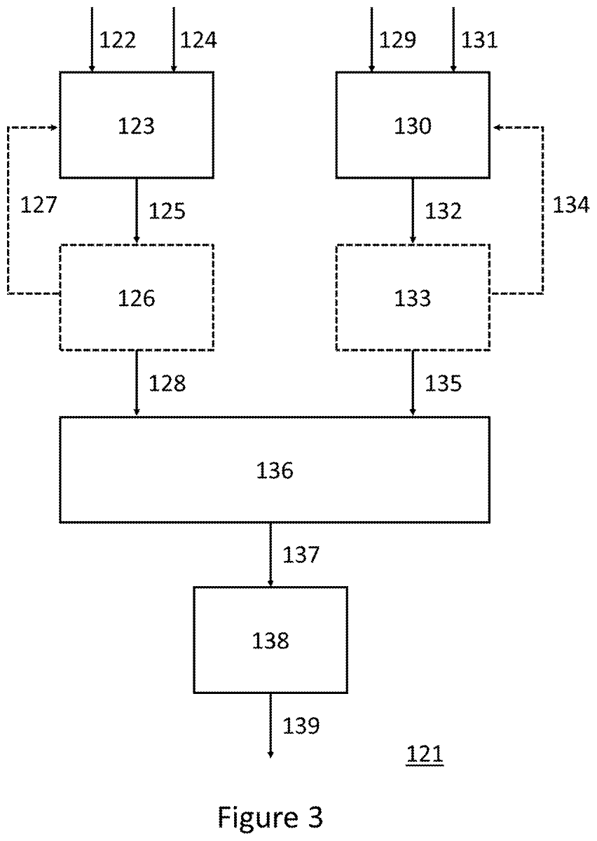

FIG. 3 gives a block diagram of a system for the chemical production of synthetic hydrocarbon products with an optimized carbon footprint according to the first embodiment 121. First reactants 122, which are methane and water, are fed into a first reformer unit 123 along with a first portion of electricity 124. The energy in the first portion of electricity 124 is used to drive the reformation of the methane and water into a hydrogen-rich syngas initial product 125. The hydrogen-rich syngas initial product 125 has a hydrogen to carbon monoxide ratio of greater than 2.5.

The hydrogen-rich syngas initial product 125 may flow into an optional hydrogen-rich syngas initial product conditioner 126. In the optional hydrogen-rich syngas initial product conditioner 126 unwanted molecules (such as water, carbon dioxide, sulfur-containing molecules) can be removed and the gases may be compressed, and/or an optional first recycling line 127 may be included to reinject a portion of the gases back into the first reformer unit 123. Gases not recycled to the first reformer unit 123 exit the optional hydrogen-rich syngas initial product conditioner 126 as a conditioned hydrogen-rich syngas initial product 128. If the optional hydrogen-rich syngas initial product conditioner 126 is not included the hydrogen-rich syngas initial product 125 and the conditioned hydrogen-rich syngas initial product 128 are equivalent.

Second reactants 129, which are methane and carbon dioxide, are fed into a second reformer unit 130 along with a second portion of electricity 131. The energy in the second portion of electricity 131 is used to drive the reformation of the methane and carbon dioxide into a hydrogen-lean syngas initial product 132. The hydrogen-lean syngas initial product 132 has a hydrogen to carbon monoxide ratio of 0 to 1.5.

The hydrogen-lean syngas initial product 132 may flow into an optional hydrogen-lean syngas initial product conditioner 133. In the optional hydrogen-lean syngas initial product conditioner 133 unwanted molecules (such as water, carbon dioxide, sulfur-containing molecules) can be removed and the gases may be compressed, and/or an optional second recycling line 134 may be included to reinject a portion of the gases back into the second reformer unit 130. Gases not recycled to the second reformer unit 130 exit the optional hydrogen-lean syngas initial product conditioner 133 as a conditioned hydrogen-lean syngas initial product 135. If the optional hydrogen-lean syngas initial product conditioner 133 is not included the hydrogen-lean syngas initial product 132 and the conditioned hydrogen-lean syngas initial product 135 are equivalent.

The conditioned hydrogen-rich syngas initial product 128 and the conditioned hydrogen-lean syngas initial product 135 flow into a conditioner 136. The conditioner 136 alters the properties (composition, temperature, pressure) of the gases to that which is required downstream. The conditioner 136 mixes the conditioned hydrogen-rich syngas initial product 128 and the conditioned hydrogen-lean syngas initial product 135. The conditioner 136 may also compress the gases, remove unwanted molecules (such as water, carbon dioxide, sulfur-containing molecules), and add additional molecules. The amount of conditioning that must occur in the conditioner 136 depends partly on if the optional hydrogen-rich syngas initial product conditioner 126 and the optional hydrogen-lean syngas initial product conditioner 133 were included. Although not shown a recycling line could also be included flowing from the conditioner 136 to the first reformer unit 123, the second reformer unit 130, or both reformers. Conditioned syngas 137 exits the conditioner 136.

The conditioned syngas 137 flows to a Fischer-Tropsch unit 138 where a synthetic hydrocarbon product 139 is formed. Most synthetic hydrocarbon products 139 require a syngas with a hydrogen to carbon monoxide ratio of about 2. By separately controlling the throughput of the first reformer unit 123 and the second reformer unit 130, syngas with ratios between about 1 and 3, could be produced. By driving the reforming process with at least a portion of the electricity made without emitting greenhouse gases the carbon footprint of the resultant synthetic hydrocarbon product 139 can be reduced as compared to the state-of-the-art.

Preferably the first reformer unit 123 and the second reformer unit 130 comprise plasma-based reformer units, such as, DC glow discharge, radio frequency discharge, arc discharge, corona discharge, dielectric barrier discharge, microwave discharge, AC discharge, or a gliding arc discharge. More preferably the first reformer unit 123 and the second reformer unit 130 comprise a microwave discharge. The operating pressure of the first reformer unit 123 and the second reformer unit 130 is preferably between 0.1 and 10 atm. More preferably the operating pressure of the first reformer unit 123 and the second reformer unit 130 are between 0.95 and 5 atm.

Regarding recycling in this example, including an optional first recycling line 127 and/or an optional second recycling line 134 may help prevent solid carbon formation in the first reformer unit 123 and/or the second reformer unit 130. The optional hydrogen-rich syngas initial product conditioner 126 and the optional hydrogen-lean syngas initial product conditioner 133 may simply comprise a filter to remove any solids and a pump to drive the flows back to the reforming units. Hydrogen-rich gases may prove best for reducing carbon solid formation within the reformer units, as such it is also possible to include an optional recycling line from optional hydrogen-rich syngas initial product conditioner 126 to the second reformer unit 130. The recycling of hydrocarbon-rich downstream byproducts produced in the Fischer-Tropsch unit 138 to the first reformer unit 123, second reformer unit 130, or both reformer units will help to improve efficiency and reduce consumables consumption.

The conditioner 136 will likely comprise a compressor as Fischer-Tropsch processes usually require pressures over 10 atm. Depending on the sulfur content of the methane source used in the first reactants 122 and second reactants 129, the conditioner 136 may also comprise a sulfur removal bed. Further, depending on the requirements of the Fischer-Tropsch unit 138, slipped water and carbon dioxide may need to be reduced as well using a vapor-liquid separator and/or amine scrubbing.

While the production of a synthetic hydrocarbon product 139 has been described above the conditioned syngas 137 could also be used as reduction gas for steel refining, to make methanol, to make alcohols, or to make aldehydes. Each alternative product may require syngas with a different hydrogen to carbon monoxide ratio, the throughput of the first reformer unit 123 and the second reformer unit 130 may be altered to match the ratio needed.

### Embodiment 2

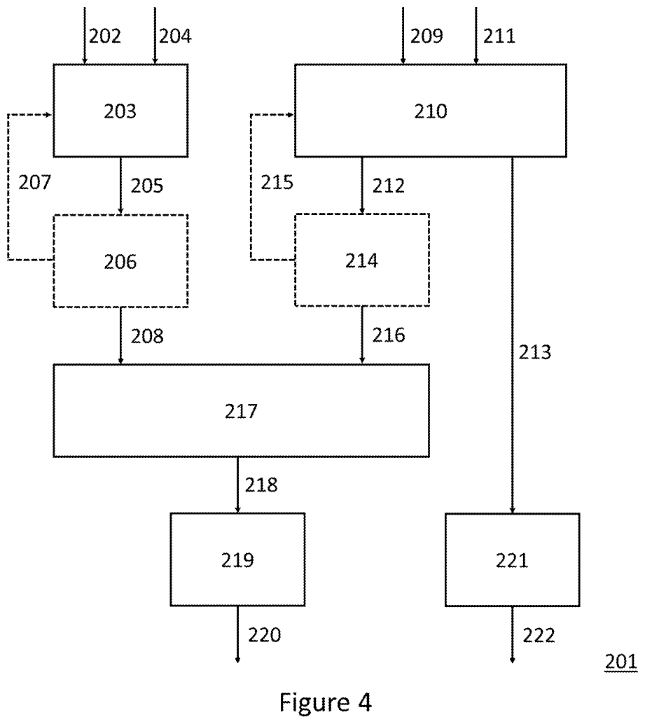

FIG. 4 gives a block diagram of a system for chemical production with an optimized carbon footprint according to the second embodiment 201. First reactants 202 are fed into a first reformer unit 203 along with a first portion of electricity 204. The energy in the first portion of electricity 204 is used to drive the reformation of the first reactants 202 into a first initial product 205. The first reformer unit 203 is configured to use the first portion of electricity 204 to molecularly alter the composition of the first reactants 202.

The first initial product 205 may flow into an optional first initial product conditioner 206. In the optional first initial product conditioner 206 unwanted molecules (such as water, carbon dioxide, sulfur-containing molecules) can be removed and the gases may be compressed, and/or an optional first recycling line 207 may be included to reinject a portion of the gases back into the first reformer unit 203. Gases not recycled to the first reformer unit 203 exit the optional first initial product conditioner 206 as a first conditioned initial product 208. If an optional first initial product conditioner 206 is not included the first initial product 205 and first conditioned initial product 208 are equivalent.

Second reactants 209 are fed into a second reformer unit 210 along with a second portion of electricity 211. The energy in the second portion of electricity 211 is used to drive the reformation of the second reactants 209 into a second initial product 212 and a second secondary initial product 213. The second reformer unit 210 is configured to use the second portion of electricity 211 to molecularly alter the composition of the second reactants 209.

The second initial product 212 may flow into an optional second initial product conditioner 214. In the optional second initial product conditioner 214 unwanted molecules (such as water, carbon dioxide, sulfur-containing molecules) can be removed and the gases may be compressed, and/or an optional second recycling line 215 may be included to reinject a portion of the gases back into the second reformer unit 210. Gases not recycled to the second reformer unit 210 exit the optional second initial product conditioner 214 as a second conditioned initial product 216. If an optional second initial product conditioner 214 is not included the second initial product 212 and second conditioned initial product 216 are equivalent.

The first conditioned initial product 208 and the second conditioned initial product 216 flow into a conditioner 217. The conditioner 217 alters the properties (composition, temperature, pressure) of the gases to that which is required downstream. The conditioner 217 mixes the first conditioned initial product 208 and the second conditioned initial product 216. The conditioner 217 may also compress the gases, remove unwanted molecules (such as water, carbon dioxide, sulfur-containing molecules), and add additional molecules. The amount of conditioning that must occur in the conditioner 217 depends partly on if the optional first initial product conditioner 206 and the optional second initial product conditioner 214 were included. Although not shown, a recycling line could also be included flowing from the conditioner 217 to the first reformer unit 203, the second reformer unit 210, or both reformers. A conditioned intermediate product 218 exits the conditioner 217.

The conditioned intermediate product 218 flows to a processing unit 219 where a final chemical product 220 is formed. The processing unit 219 may be as simple as bottling or depositing the conditioned intermediate product 218 into a pipeline. The processing unit 219 may also include further molecule processing steps such as ammonia, urea, methanol, alcohols, metallic ore reduction and hydrocarbon formation or oil refining.

The second secondary initial product 213, produced in the second reformer unit 210, is fed to a secondary product processing unit 221 where a secondary final chemical product 222 is formed. If needed, though not shown, an additional conditioning unit could be included to prepare the second secondary initial product 213 for the secondary product processing unit 221. The secondary product processing unit 221 may be as simple as packing, bottling, or moving the second secondary initial product 213. The secondary product processing unit 221 may also include further molecule processing steps such as forming carbon dioxide for enhanced oil and gas recovery. The sale of the secondary final chemical product 222 may help offset the costs of the final chemical product 220, making the price of the final chemical product 220 which has a reduced carbon footprint more competitive with state-of-the-art products that do not have a reduced carbon footprint.

### Example of the Second Embodiment: a System for the Chemical Production of Synthetic Hydrocarbon Products and Oxygen with an Optimized Carbon Footprint

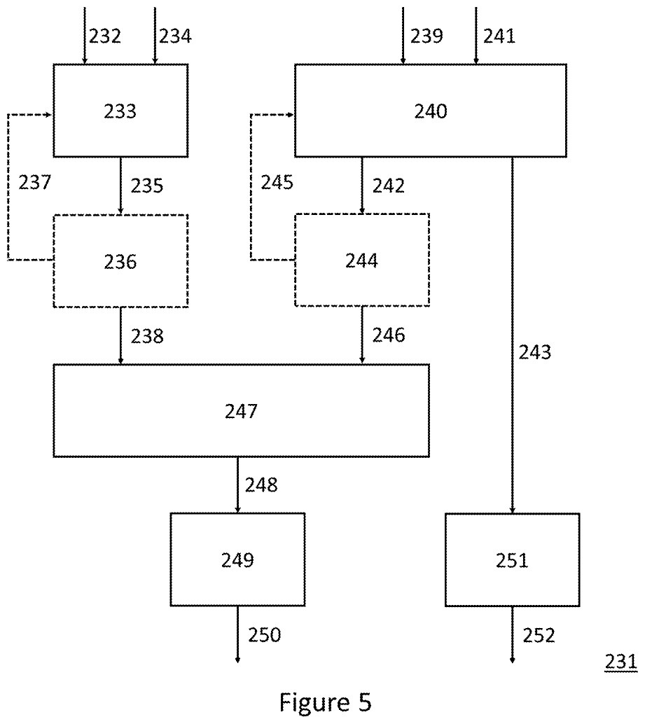

FIG. 5 gives a block diagram of a system for the chemical production of synthetic hydrocarbon products and oxygen with an optimized carbon footprint according to the second embodiment 231. First reactants 232, which are methane and carbon dioxide, are fed into a first reformer unit 233 along with a first portion of electricity 234. The energy in the first portion of electricity 234 is used to drive the reformation of the methane and carbon dioxide into a hydrogen-lean syngas initial product 235. The hydrogen-lean syngas initial product 235 has a hydrogen to carbon monoxide ratio of 0 to 1.5.

The hydrogen-lean syngas initial product 235 may flow into an optional hydrogen-lean syngas initial product conditioner 236. In the optional hydrogen-lean syngas initial product conditioner 236 unwanted molecules (such as water, carbon dioxide, sulfur-containing molecules) can be removed and the gases may be compressed, and/or an optional first recycling line 237 may be included to reinject a portion of the gases back into the first reformer unit 233. Gases not recycled to the first reformer unit 233 exit the optional hydrogen-lean syngas initial product conditioner 236 as a conditioned hydrogen-lean syngas initial product 238. If the optional hydrogen-lean syngas initial product conditioner 236 is not included the hydrogen-lean syngas initial product 235 and the conditioned hydrogen-lean syngas initial product 238 are equivalent.

Water 239 is fed into an electrolysis unit 240 along with a second portion of electricity 241. The energy in the second portion of electricity 241 is used to drive the reformation of the water 239 into hydrogen 242 and oxygen 243.

The hydrogen 242 may flow into an optional hydrogen conditioner 244. In the optional hydrogen conditioner 244 any unwanted molecules (such as water or oxygen) can be removed and the gas may be compressed, and/or an optional second recycling line 245 may be included to reinject a portion of the gases back into the electrolysis unit 240. Gases not recycled to the electrolysis unit 240 exit the optional hydrogen conditioner 244 as conditioned hydrogen 246. If the optional hydrogen conditioner 244 is not included the hydrogen 242 and the conditioned hydrogen 246 are equivalent.

The conditioned hydrogen-lean syngas initial product 238 and the conditioned hydrogen 246 flow into a conditioner 247. The conditioner 247 alters the properties (composition, temperature, pressure) of the gases to that which is required downstream. The conditioner 247 mixes the conditioned hydrogen-lean syngas initial product 238 and the conditioned hydrogen 246. The conditioner 247 may also compress the gases, remove unwanted molecules (such as water, carbon dioxide, sulfur-containing molecules), and add additional molecules. The amount of conditioning that must occur in the conditioner 247 depends partly on if the optional hydrogen-lean syngas initial product conditioner 236 and the optional hydrogen conditioner 244 were included. Although not shown, a recycling line could also be included flowing from the conditioner 247 to the first reformer unit 233, the electrolysis unit 240, or both. Conditioned syngas 248 exits the conditioner 247.

The conditioned syngas 248 flows to a Fischer-Tropsch unit 249 where a synthetic hydrocarbon product 250 is formed. Most synthetic hydrocarbon products 250 require syngas with a hydrogen to carbon monoxide ratio of about 2. By separately controlling the throughput of the first reformer unit 233 and the electrolysis unit 240, syngas with ratios between about 1 and 3, could be produced. By driving the reforming process with at least a portion of the electricity made without emitting greenhouse gases the carbon footprint of the resultant synthetic hydrocarbon products 250 can be reduced as compared to the state-of-the-art.

Oxygen 243, produced in the electrolysis unit 240, is fed to a compressor 251 where compressed oxygen 252 is formed. If needed, though not shown, an oxygen conditioning unit could be included to prepare the oxygen 243 for the compressor 251. The sale of the compressed oxygen 252 may help offset the costs of the synthetic hydrocarbon product 250, making the price of the synthetic hydrocarbon product 250 which has a reduced carbon footprint more competitive with state-of-the-art hydrocarbon products that do not have a reduced carbon footprint.

Preferably the first reformer unit 233 comprise a plasma-based reformer, such as, DC glow discharge, radio frequency discharge, arc discharge, corona discharge, dielectric barrier discharge, microwave discharge, AC discharge, or a gliding arc discharge. More preferably the first reformer unit 233 comprises a microwave discharge. The operating pressure of the first reformer unit 233 is preferably between 0.1 and 10 atm. More preferably the operating pressure of the first reformer unit 233 is between 0.95 and 5 atm.

Regarding recycling in this example, including the optional first recycling line 237 may help prevent solid carbon formation in the first reformer unit 233. The inclusion of the optional second recycling line 245 may be unnecessary. The optional hydrogen-lean syngas initial product conditioner 236 may simply comprise a filter to remove any solids and a pump to drive the flows back to the reforming units. The recycling of hydrocarbon-rich downstream byproducts (not shown) produced in the Fischer-Tropsch unit 249 to the first reformer unit 233 will help to improve efficiency and reduce consumables consumption.

The conditioner 247 will likely comprise a compressor as Fischer-Tropsch processes usually require pressures over 10 atm.

Depending on the sulfur content of the methane source used in the first reactants 232, the conditioner 247 may also comprise a sulfur removal bed. Further, depending on the requirements of the Fischer-Tropsch unit 249, formed water or slipped carbon dioxide may need to be reduced as well using a vapor-liquid separator and/or amine scrubbing.

While the production of a synthetic hydrocarbon product 250 has been described above the conditioned syngas 248 could also be used as reduction gas for steel refining, to make methanol, to make alcohols, or to make aldehydes. Each alternative product may require syngas with a different hydrogen to carbon monoxide ratio, the throughput of the first reformer unit 233 and the electrolysis unit 240 may be altered to match the ratio needed.

### Example of the Second Embodiment: a System for the Chemical Production of Synthetic Hydrocarbon Products and Carbon with an Optimized Carbon Footprint

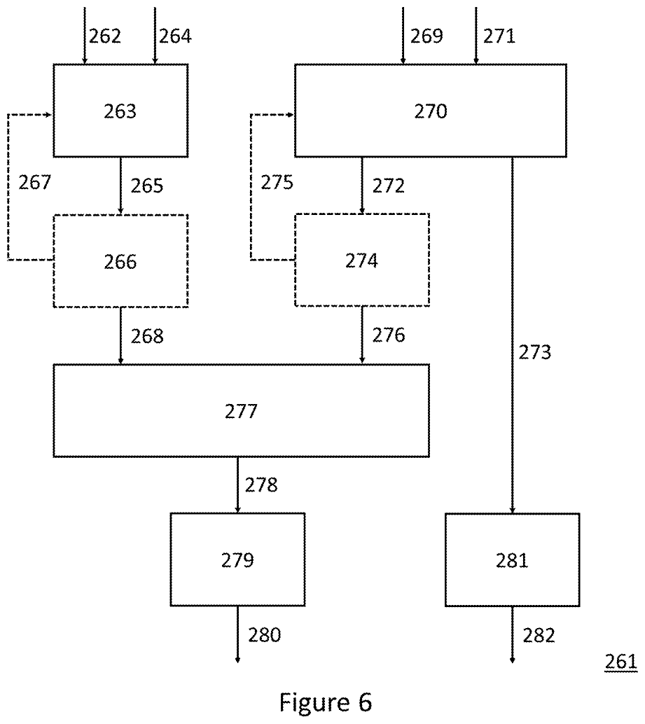

FIG. 6 gives a block diagram of a system for the chemical production of synthetic hydrocarbon products and carbon with an optimized carbon footprint according to the second embodiment 261. First reactants 262, which are methane and carbon dioxide, are fed into a first reformer unit 263 along with a first portion of electricity 264. The energy in the first portion of electricity 264 is used to drive the reformation of the methane and carbon dioxide into a hydrogen-lean syngas initial product 265. The hydrogen-lean syngas initial product 265 has a hydrogen to carbon monoxide ratio of 0 to 1.5.

The hydrogen-lean syngas initial product 265 may flow into an optional hydrogen-lean syngas initial product conditioner 266. In the optional hydrogen-lean syngas initial product conditioner 266 unwanted molecules (such as water, carbon dioxide, sulfur-containing molecules) can be removed and the gases may be compressed, and/or an optional first recycling line 267 may be included to reinject a portion of the gases back into the first reformer unit 263. Gases not recycled to the first reformer unit 263 exit the optional hydrogen-lean syngas initial product conditioner 266 as a conditioned hydrogen-lean syngas initial product 268. If the optional hydrogen-lean syngas initial product conditioner 266 is not included the hydrogen-lean syngas initial product 265 and the conditioned hydrogen-lean syngas initial product 268 are equivalent.

Methane 269 is fed into a second reformer unit 270 along with a second portion of electricity 271. The energy in the second portion of electricity 271 is used to drive the reformation (pyrolysis) of the methane 269 into hydrogen 272 and carbon 273.

The hydrogen 272 may flow into an optional hydrogen conditioner 274. In the optional hydrogen conditioner 274 any unwanted molecules (such as water, carbon dioxide, sulfur-containing molecules) can be removed and the gas may be compressed, and/or an optional second recycling line 275 may be included to reinject a portion of the gases back into the second reformer unit 270. Gases not recycled to the second reformer unit 270 exit the optional hydrogen conditioner 274 as conditioned hydrogen 276. If the optional hydrogen conditioner 274 is not included the hydrogen 272 and the conditioned hydrogen 276 are equivalent.

The conditioned hydrogen-lean syngas initial product 268 and the conditioned hydrogen 276 flow into a conditioner 277. The conditioner 277 alters the properties (composition, temperature, pressure) of the gases to that which is required downstream. The conditioner 277 mixes the conditioned hydrogen-lean syngas initial product 268 and the conditioned hydrogen 276. The conditioner 277 may also compress the gases, remove unwanted molecules (such as water, carbon dioxide, sulfur-containing molecules), and add additional molecules. The amount of conditioning that must occur in the conditioner 277 depends partly on if the optional hydrogen-lean syngas initial product conditioner 266 and the optional hydrogen conditioner 274 were included. Although not shown, a recycling line could also be included flowing from the conditioner 277 to the first reformer unit 263, the second reformer unit 270, or both. Conditioned syngas 278 exits the conditioner 277.

The conditioned syngas 278 flows to a Fischer-Tropsch unit 279 where synthetic hydrocarbon products 280 are formed. Most synthetic hydrocarbon products 280 require syngas with a hydrogen to carbon monoxide ratio of about 2. By separately controlling the throughput of the first reformer unit 263 and the second reformer unit 270, syngas with ratios between about 1 and 3, could be produced. By driving the reforming process with at least a portion of the electricity made without emitting greenhouse gases the carbon footprint of the resultant synthetic hydrocarbon products 280 can be reduced as compared to the state-of-the-art.

Carbon 273, produced in the second reformer unit 270, is fed to a carbon processing unit 281 where carbon product 282 is formed. If needed, though not shown, a carbon conditioning unit could be included to prepare the carbon 273 for the carbon processing unit 281. The sale of the carbon product 282 may help offset the costs of the synthetic hydrocarbon product 280, making the price of the synthetic hydrocarbon product 280 which has a reduced carbon footprint more competitive with state-of-the-art hydrocarbon products that do not have a reduced carbon footprint.

Preferably the first reformer unit 263 and the second reformer unit 270 comprise plasma-based reformers, such as, DC glow discharge, radio frequency discharge, arc discharge, corona discharge, dielectric barrier discharge, microwave discharge, AC discharge, or a gliding arc discharge. More preferably the first reformer unit 233 and the second reformer unit 270 comprise microwave discharges. The operating pressure of the first reformer unit 233 and the second reformer unit 270 are preferably between 0.1 and 10 atm. More preferably the operating pressure of the first reformer unit 233 and the second reformer unit 270 are between 0.95 and 5 atm.

Regarding recycling in this example, including an optional first recycling line 267 and/or an optional second recycling line 275 may help prevent solid carbon formation in the first reformer unit 263 and/or the second reformer unit 270. The inclusion of the optional second recycling line 275 may be especially useful in the preferred embodiment where the second reformer unit is a plasma-based reformer. In such a reformer hydrogen gas from the second recycling line 275 could be used as a plasma gas within the plasma region of the reformer, and the methane 269 could be injected downstream from the plasma-region into the hot hydrogen gas to ensure carbon does not deposit within the plasma-region.

The optional hydrogen-lean syngas initial product conditioner 266 and the optional hydrogen conditioner 274 may simply comprise a filter to remove any solids and a pump to drive the flows back to the reforming units. Hydrogen-rich gases may prove best for reducing carbon solid formation within the reformer units, as such it is also possible to include an optional recycling line from the optional hydrogen conditioner 274 to the first reformer unit 263. The recycling of hydrocarbon-rich downstream byproducts produced in the Fischer-Tropsch unit 279 to the first reformer unit 263, second reformer unit 270, or both reformer units will help to improve efficiency and reduce consumables consumption.

The conditioner 277 will likely comprise a compressor as Fischer-Tropsch processes usually require pressures over 10 atm. Depending on the sulfur content of the methane source used in the first reactants 262 and the methane 269, the conditioner 277 may also comprise a sulfur removal bed. Further, depending on the requirements of the Fischer-Tropsch unit 279, formed water or slipped carbon dioxide may need to be reduced as well using a vapor-liquid separator and/or amine scrubbing.

While the production of a synthetic hydrocarbon product 280 has been described above the conditioned syngas 278 could also be used as reduction gas for steel refining, to make methanol, to make alcohols, or to make aldehydes. Each alternative product may require syngas with a different hydrogen to carbon monoxide ratio, the throughput of the first reformer unit 263 and the second reformer unit 270 may be altered to match the ratio needed.

The carbon product 282 produced will depend largely on the quality of the carbon 273 produced. If high quality carbons such as carbon nanotubes, graphene, graphite, or carbon black are produced the carbon processing unit 281 may include product separation, refining, and/or packaging of the carbon product 282. If the carbon 273 is not directly marketable as a high-end carbon product it could be used as biochar, reverse mined (buried) for carbon sequestration, or sequestered as carbon dioxide through enhanced oil and gas recovery (additional details on this use will be presented later).

### Example of the Second Embodiment: a System for the Chemical Production of Ammonia and Carbon with an Optimized Carbon Footprint

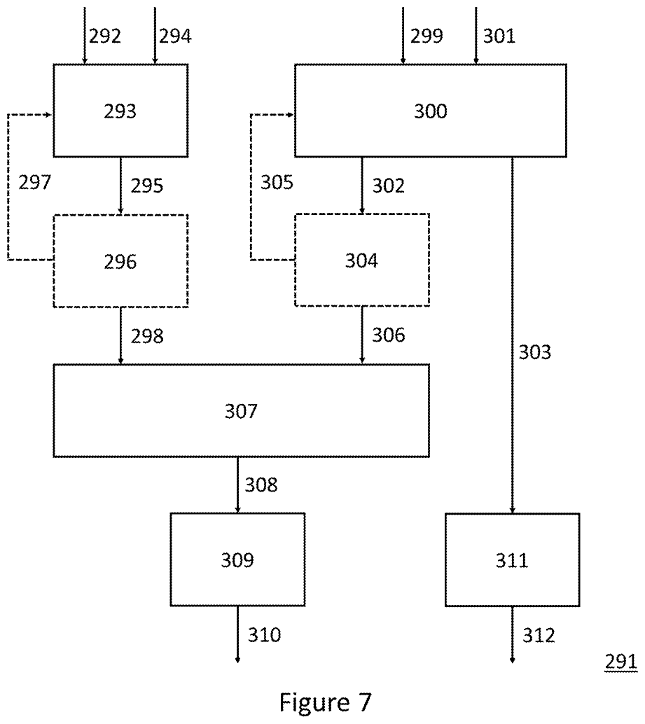

FIG. 7 gives a block diagram of a system for the chemical production of ammonia and carbon with an optimized carbon footprint according to the second embodiment 291. Air 292 is taken into an air separation unit 293 along with a first portion of electricity 294. The energy in the first portion of electricity 264 is used to drive the isolation of nitrogen from other gases in air, thus reforming the air 292 into a stream of nitrogen 295. Nitrogen-lean air, not shown, may be vented.

The nitrogen 295 may flow into an optional nitrogen conditioner 296. In the optional nitrogen conditioner 296 unwanted molecules (such as water, oxygen, carbon dioxide) can be removed and the gas may be compressed, and/or an optional first recycling line 297 may be included to reinject a portion of the gas back into the air separation unit 293. Gases not recycled to the air separation unit 293 exit the optional nitrogen conditioner 296 as conditioned nitrogen 298. If the optional nitrogen conditioner 296 is not included the nitrogen 295 and the conditioned nitrogen 298 are equivalent.

Methane 299 is fed into a second reformer unit 300 along with a second portion of electricity 301. The energy in the second portion of electricity 301 is used to drive the reformation (pyrolysis) of the methane 299 into hydrogen 302 and carbon 303.

The hydrogen 302 may flow into an optional hydrogen conditioner 304. In the optional hydrogen conditioner 304 any unwanted molecules (such as water, carbon dioxide, sulfur-containing molecules) can be removed and the gas may be compressed, and/or an optional second recycling line 305 may be included to reinject a portion of the gases back into the second reformer unit 300. Gases not recycled to the second reformer unit 300 exit the optional hydrogen conditioner 304 as conditioned hydrogen 306. If the optional hydrogen conditioner 304 is not included the hydrogen 302 and the conditioned hydrogen 306 are equivalent.

The conditioned nitrogen 298 and the conditioned hydrogen 306 flow into a conditioner 307. The conditioner 307 alters the properties (composition, temperature, pressure) of the gases to that which is required downstream. The conditioner 307 mixes the conditioned nitrogen 298 and the conditioned hydrogen 306. The conditioner 307 may also compress the gases, remove unwanted molecules (such as water, carbon dioxide, sulfur-containing molecules), and add additional molecules. The amount of conditioning that must occur in the conditioner 307 depends partly on if the optional nitrogen conditioner 296 and the optional hydrogen conditioner 304 were included. Although not shown, a recycling line could also be included flowing from the conditioner 307 to the air separation unit 293, the second reformer unit 300, or both. Conditioned nitrogen and hydrogen 308 exit the conditioner 307.

The conditioned nitrogen and hydrogen 308 flows to a Haber-Bosch unit 309 where ammonia 310 is formed. Ammonia 310 production requires a hydrogen to nitrogen ratio of about 3. By separately controlling the throughput of the air separation unit 293 and the second reformer unit 300, the hydrogen to nitrogen ratio can be tailored to the application. By driving the reforming process with at least a portion of the electricity made without emitting greenhouse gases the carbon footprint of the resultant ammonia 310 can be reduced as compared to the state-of-the-art.

Carbon 303, produced in the second reformer unit 300, is fed to a carbon processing unit 311 where carbon product 312 is formed. If needed, though not shown, a carbon conditioning unit could be included to prepare the carbon 303 for the carbon processing unit 311. The sale of the carbon product 312 may help offset the costs of the ammonia 310, making the price of the ammonia 310 which has a reduced carbon footprint more competitive with state-of-the-art ammonia products that do not have a reduced carbon footprint.

Preferably the second reformer unit 300 comprises a plasma-based reformer, such as, DC glow discharge, radio frequency discharge, arc discharge, corona discharge, dielectric barrier discharge, microwave discharge, AC discharge, or a gliding arc discharge. More preferably the second reformer unit 300 comprises a microwave discharge. The operating pressure of the second reformer unit 300 is preferably between 0.1 and 10 atm. More preferably the operating pressure of the second reformer unit 300 is between 0.95 and 5 atm.

Regarding recycling in this example, the inclusion of the optional first recycling line 297 may be unnecessary. Including the optional second recycling line 305 may help prevent solid carbon formation in the second reformer unit 300. The inclusion of the optional second recycling line 305 may be especially useful in the preferred embodiment where the second reformer unit is a plasma-based reformer. In such a reformer hydrogen gas from the second recycling line 305 could be used as a plasma gas within the plasma region of the reformer, and the methane 299 could be injected downstream from the plasma-region into the hot hydrogen gas to ensure carbon does not deposit within the plasma-region.

The conditioner 307 will likely comprise a compressor as Haber-Bosch processes usually require pressures around 200 atm. Depending on the sulfur content of the methane source used for methane 299 the conditioner 307 may also comprise a sulfur removal bed. Further, depending on the requirements of the Haber-Bosch unit 309, formed water or slipped carbon dioxide may need to be reduced as well using a vapor-liquid separator and/or amine scrubbing.

While the production of ammonia 310 has been described above additional processing steps may occur after the production of ammonia to form other products. Other possible products include urea, uric acid, ammonia hydroxide, and/or ammonium nitrate and other fertilizers.

The carbon product 312 produced will depend largely on the quality of the carbon 303 produced. If high quality carbons such as carbon nanotubes, graphene, graphite, or carbon black are produced the carbon processing unit 311 may include product separation, refining, and/or packaging of the carbon product 312. If the carbon 303 is not directly marketable as a high-end carbon product it could be used as biochar, reverse mined (buried) for carbon sequestration, or sequestered as carbon dioxide through enhanced oil and gas recovery (additional details on this use will be presented later).

### Embodiment 3

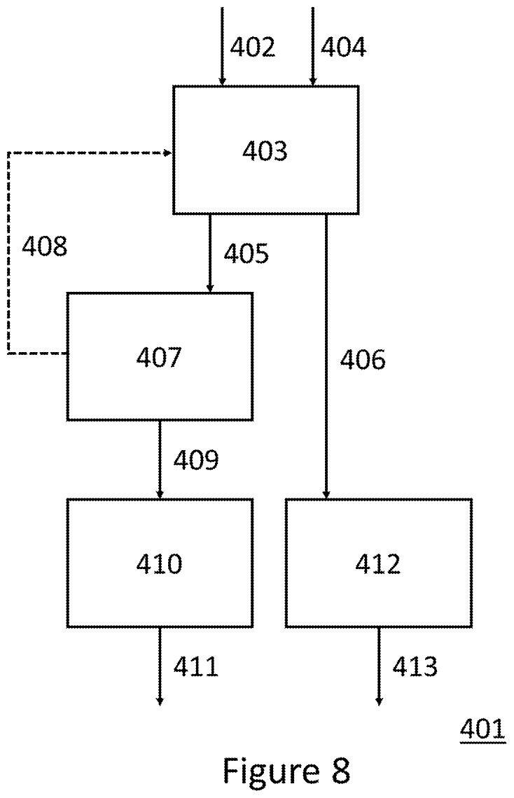

FIG. 8 gives a block diagram of a system for chemical production with an optimized carbon footprint according to the third embodiment 401. First reactants 402 are fed into a first reformer unit 403 along with a first portion of electricity 404.

The energy in the first portion of electricity 404 is used to drive the reformation of the first reactants 402 into a first initial product 405 and a first secondary initial product 406. The first reformer unit 403 is configured to use the first portion of electricity 404 to molecularly alter the composition of the first reactants 402.

The first initial product 405 flows to a conditioner 407. The conditioner 407 alters the properties (composition, temperature, pressure) of the gases to that which is required downstream. The conditioner 407 may compress, remove unwanted molecules (such as water, carbon dioxide, sulfur-containing molecules), add additional molecules, heat, and/or cool the gases. An optional first recycling line 408 can be included to return a portion of the gas to the first reformer unit 403. Any gases not recycled exit the conditioner 407 as a conditioned intermediate product 409.

The conditioned intermediate product 409 flows to a processing unit 410 where a final chemical product 411 is formed. The processing unit 410 may be as simple as bottling or depositing the conditioned intermediate product 409 into a pipeline. The processing unit 410 may also include further molecule processing steps such as ammonia, urea, methanol, alcohols, and hydrocarbon formation or oil refining.

The first secondary initial product 406, produced in the first reformer unit 403, is fed to a secondary product processing unit 412 where a secondary final chemical product 413 is formed. If needed, though not shown, an additional conditioning unit could be included to prepare the first secondary initial product 406 for the secondary product processing unit 412. The secondary product processing unit 412 may be as simple as packing, bottling, or moving the first secondary initial product 406. The secondary product processing unit 412 may also include further molecule processing steps such as forming carbon dioxide for enhanced oil and gas recovery. The sale of the secondary final chemical product 413 may help offset the costs of the final chemical product 411, making the price of the final chemical product 411 which has a reduced carbon footprint more competitive with state-of-the-art products that do not have a reduced carbon footprint.

### Example of the third Embodiment: a System for the Chemical Production of Hydrogen and Carbon with an Optimized Carbon Footprint

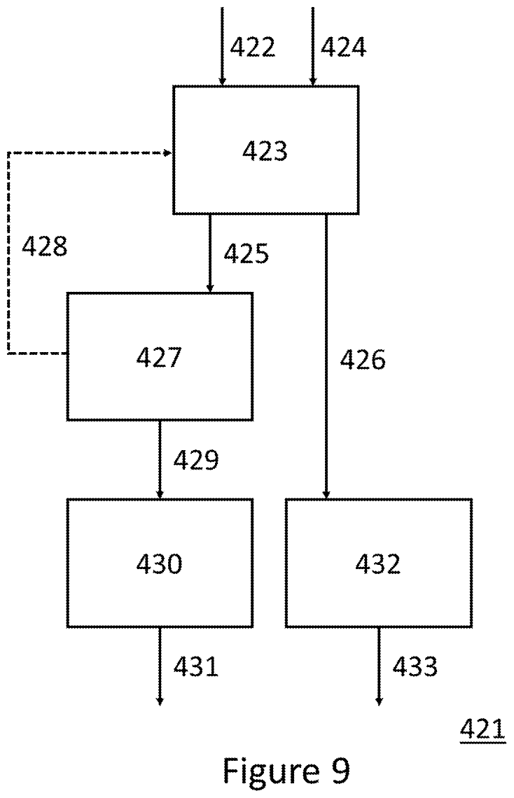

FIG. 9 gives a block diagram of a system for the chemical production of hydrogen and carbon with an optimized carbon footprint according to the third embodiment 421. Methane 422 is fed into a first reformer unit 423 along with a first portion of electricity 424. The energy in the first portion of electricity 424 is used to drive the reformation (pyrolysis) of the methane 422 into hydrogen 425 and carbon 426.

The hydrogen 425 flows to a conditioner 427. The conditioner 427 alters the properties (composition, temperature, pressure) of the gases to that which is required downstream. The conditioner 427 may compress, remove unwanted molecules (such as water, carbon dioxide, sulfur-containing molecules), add additional molecules, heat, and/or cool the gases. An optional first recycling line 428 can be included to return a portion of the gas to the first reformer unit 423. Any gases not recycled exit the conditioner 427 as conditioned hydrogen 429.

The conditioned hydrogen 429 flows to a hydrogen processing unit 430 where a hydrogen product 431 is formed. The hydrogen processing unit 430 may be as simple as bottling or depositing the conditioned hydrogen 429 into a pipeline. By driving the reforming process with at least a portion of the electricity made without emitting greenhouse gases the carbon footprint of the resultant hydrogen product 431 can be reduced as compared to the state-of-the-art.

Carbon 426, produced in the first reformer unit 423, is fed to a carbon processing unit 432 where carbon product 433 is formed. If needed, though not shown, a carbon conditioning unit could be included to prepare the carbon 426 for the carbon processing unit 432. The sale of the carbon product 433 may help offset the costs of the hydrogen product 431, making the price of the hydrogen product 431 which has a reduced carbon footprint more competitive with state-of-the-art hydrogen products that do not have a reduced carbon footprint.

Preferably the first reformer unit 423 comprises a plasma-based reformer, such as, DC glow discharge, radio frequency discharge, arc discharge, corona discharge, dielectric barrier discharge, microwave discharge, AC discharge, or a gliding arc discharge. More preferably the first reformer unit 423 comprises a microwave discharge. The operating pressure of the first reformer unit 423 is preferably between 0.1 and 10 atm. More preferably the operating pressure of the first reformer unit 423 is between 0.95 and 5 atm.

Regarding recycling in this example, the inclusion of the optional first recycling line 428 may help prevent solid carbon formation in critical areas of the first reformer unit 423. The inclusion of the optional first recycling line 428 may be especially useful in the preferred embodiment where the first reformer unit is a plasma-based reformer. In such a reformer hydrogen gas from the first recycling line 428 could be used as a plasma gas within the plasma region of the reformer, and the methane 422 could be injected downstream from the plasma-region into the hot hydrogen gas to ensure carbon does not deposit within the plasma-region.

The conditioner 427 may comprise a compressor. Depending on the sulfur content of the methane source used for methane 422 the conditioner 427 may also comprise a sulfur removal bed. Further, depending on the hydrogen purity requirements downstream, water or carbon dioxide may need to be reduced as well using a vapor-liquid separator and/or amine scrubbing.

While the production of hydrogen product 431 has been described above additional processing steps may occur after the production of hydrogen to form other products. The hydrogen processing unit 430 may also include further molecule processing steps such interfacing with other molecule sources to form ammonia, urea, methanol, alcohols, and hydrocarbon formation or oil refining.

The carbon product 433 produced will depend largely on the quality of the carbon 426 produced. If high quality carbons such as carbon nanotubes, graphene, graphite, or carbon black are produced the carbon processing unit 432 may include product separation, refining, and/or packaging of the carbon product 433. If the carbon 426 is not directly marketable as a high-end carbon product it could be used as biochar, reverse mined (buried) for carbon sequestration, or sequestered as carbon dioxide through enhanced oil and gas recovery (additional details on this use will be presented later).

### Embodiment 4

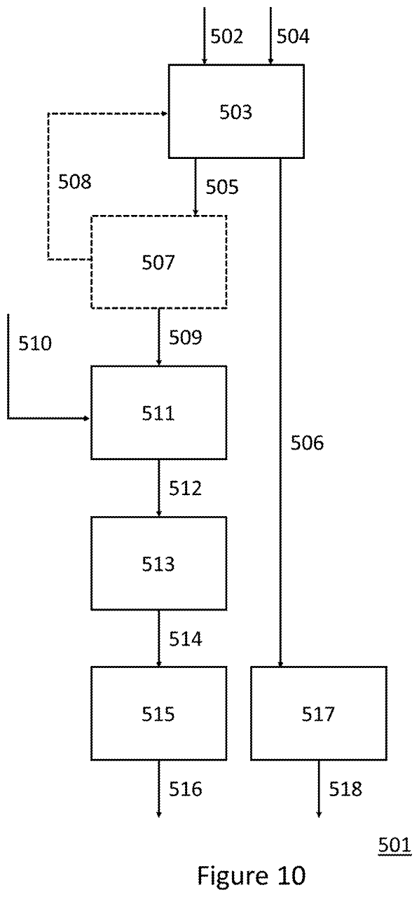

FIG. 10 gives a block diagram of a system for chemical production with an optimized carbon footprint according to the fourth embodiment 501. First reactants 502 are fed into a first reformer unit 503 along with a first portion of electricity 504. The energy in the first portion of electricity 504 is used to drive the reformation of the first reactants 502 into a first initial product 505 and a first secondary initial product 506. The first reformer unit 503 is configured to use the first portion of electricity 504 to molecularly alter the composition of the first reactants 502.

The first initial product 505 may flow into an optional first initial product conditioner 507. In the optional first initial product conditioner 507 unwanted molecules (such as water, carbon dioxide, methane, sulfur-containing molecules) can be removed and the gases may be compressed, and/or an optional first recycling line 508 may be included to reinject a portion of the gases back into the first reformer unit 503. Gases not recycled to the first reformer unit 503 exit the optional first initial product conditioner 507 as a first conditioned initial product 509. If the optional first initial product conditioner 507 is not included the first initial product 505 and first conditioned initial product 509 are equivalent.

The first conditioned initial product 509 and second reactants 510 flow into a second reformer unit 511. In the second reformer unit 511 the first conditioned initial product 509 and second reactants 510 are reformed into a second initial product 512. The second reformer unit 511 is configured to molecularly alter the composition of the first conditioned initial product 509 and the second reactants 510.

The second initial product 512 flows into a conditioner 513. The conditioner 513 alters the properties (composition, temperature, pressure) of the gases to that which is required downstream. The conditioner 513 may compress the gases, remove unwanted molecules (such as water, carbon dioxide, methane sulfur-containing molecules), and add additional molecules. Although not shown, a recycling line could also be included flowing from the conditioner 513 to the first reformer unit 503, the second reformer unit 511, or both reformers. A conditioned intermediate product 514 exits the conditioner 513.

The conditioned intermediate product 514 flows to a processing unit 515 where a final chemical product 516 is formed. The processing unit 515 may be as simple as bottling or depositing the conditioned intermediate product 514 into a pipeline. The processing unit 515 may also include further molecule processing steps such as ammonia, urea, methanol, alcohols, and hydrocarbon formation or oil refining.

The first secondary initial product 506, produced in the first reformer unit 503, is fed to a secondary product processing unit 517 where a secondary final chemical product 518 is formed. If needed, though not shown, an additional conditioning unit could be included to prepare the first secondary initial product 506 for the secondary product processing unit 517. The secondary product processing unit 517 may be as simple as packing, bottling, or moving the first secondary initial product 506. The secondary product processing unit 517 may also include further molecule processing steps such as forming carbon dioxide for enhanced oil and gas recovery. The sale of the secondary final chemical product 518 may help offset the costs of the final chemical product 516, making the price of the final chemical product 516 which has a reduced carbon footprint more competitive with state-of-the-art products that do not have a reduced carbon footprint.

Example of the fourth embodiment: a system for the chemical production of synthetic hydrocarbon products and carbon with an optimized carbon footprint.

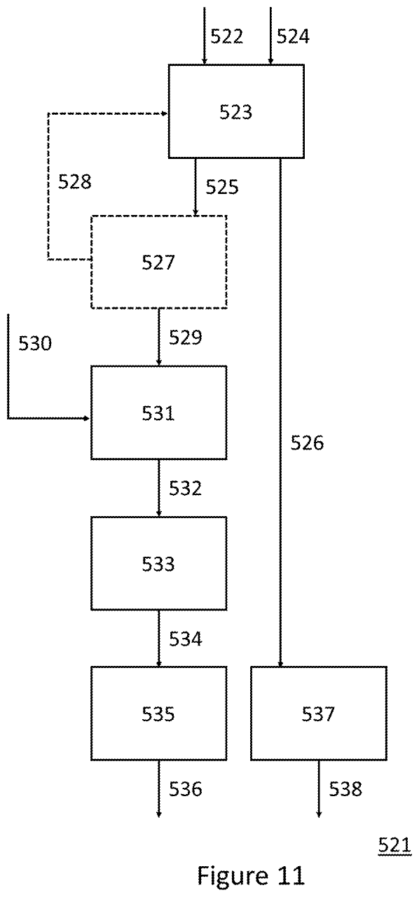

FIG. 11 gives a block diagram of a system for the chemical production of synthetic hydrocarbon products and carbon with an optimized carbon footprint according to the fourth embodiment 521. Methane 522 is fed into a first reformer unit 523 along with a first portion of electricity 524. The energy in the first portion of electricity 524 is used to drive the reformation (pyrolysis) of the methane 522 into hydrogen 525 and carbon 526.

The hydrogen 525 may flow into an optional hydrogen conditioner 527. In the optional hydrogen conditioner 527 any unwanted molecules (such as water, carbon dioxide, methane, sulfur-containing molecules) can be removed and the gas may be compressed, and/or an optional first recycling line 528 may be included to reinject a portion of the gases back into the first reformer unit 523. Gases not recycled to the first reformer unit 523 exit the optional hydrogen conditioner 527 as conditioned hydrogen 529. If the optional hydrogen conditioner 527 is not included the hydrogen 525 and the conditioned hydrogen 529 are equivalent.

The conditioned hydrogen 529 and carbon dioxide 530 flow into a reverse water-gas shift unit 531. In the reverse water-gas shift unit 531 a portion of the conditioned hydrogen 529 and carbon dioxide 530 are reformed into carbon monoxide and water, and a mixture 532 comprising syngas, water, and carbon dioxide.

The mixture 532 of syngas, water, and carbon dioxide flow into a conditioner 533. The conditioner 533 alters the properties (composition, temperature, pressure) of the gases to that which is required downstream. The conditioner 533 may remove the produced water and any slipped carbon dioxide using a vapor-liquid separator and/or amine scrubbing. The conditioner 533 may also compress the gases, remove additional unwanted molecules (such as sulfur-containing molecules), and add additional molecules. Although not shown, a recycling line could also be included flowing from the conditioner 533 to the first reformer unit 523, the reverse water-gas shift unit 531, or both. Conditioned syngas 534 exits the conditioner 533.

The conditioned syngas 534 flows to a Fischer-Tropsch unit 535 where synthetic hydrocarbon products 536 are formed. Most synthetic hydrocarbon products 536 require syngas with a hydrogen to carbon monoxide ratio of about 2. By separately controlling the throughput of the first reformer unit 523 and the reverse water-gas shift unit 531, syngas with any ratio could be produced. By driving the reforming process with at least a portion of the first portion of electricity 524 being generated without emitting greenhouse gases the carbon footprint of the resultant synthetic hydrocarbon products 536 can be reduced as compared to the state-of-the-art. Further, if the first portion of electricity 524 is generated without emitting greenhouse gases all carbon in the resultant synthetic hydrocarbon products 536 will originate from the carbon dioxide 530, thus forming a closed carbon cycle (upon combustion).

Carbon 526, produced in the first reformer unit 523, is fed to a carbon processing unit 537 where carbon product 538 is formed. If needed, though not shown, a carbon conditioning unit could be included to prepare the carbon 526 for the carbon processing unit 537. The sale of the carbon product 538 may help offset the costs of the synthetic hydrocarbon product 536, making the price of the synthetic hydrocarbon product 536 which has a reduced carbon footprint more competitive with state-of-the-art hydrocarbon products that do not have a reduced carbon footprint.

Preferably the first reformer unit 523 comprises a plasma-based reformer, such as, DC glow discharge, radio frequency discharge, arc discharge, corona discharge, dielectric barrier discharge, microwave discharge, AC discharge, or a gliding arc discharge. More preferably the first reformer unit 523 comprise a microwave discharge. The operating pressure of the first reformer unit 523 is preferably between 0.1 and 10 atm. More preferably the operating pressure of the first reformer unit 523 is between 0.95 and 5 atm.

Regarding recycling in this example, including the optional first recycling line 528 may help prevent solid carbon formation in portions of the first reformer unit 523. The inclusion of the optional first recycling line 528 may be especially useful in the preferred embodiment where the first reformer unit 523 is a plasma-based reformer. In such a reformer hydrogen gas from the first recycling line 528 could be used as a plasma gas within the plasma region of the reformer, and the methane 522 could be injected downstream from the plasma-region into the hot hydrogen gas to ensure carbon does not deposit within the plasma-region.

The optional hydrogen conditioner 527 may simply comprise a filter to remove any solids and a pump to drive the flows back to the first reformer unit 523. Depending on the pressure in the first reformer unit 523 and of the hydrogen 525 the optional hydrogen conditioner 527 may be required in order to pressurize the hydrogen 525 prior to entering the reverse water-gas shift unit 531. The carbon dioxide 530 will also have to be pressurized to match that of the hydrogen 525, or alternatively the carbon dioxide 530 could be compressed with the hydrogen 525 in the hydrogen conditioner 527, not shown.

As mentioned previously, the conditioner 533 will likely comprise units for the removal of produced water and any slipped carbon dioxide. The conditioner 533 will likely also comprise a compressor as Fischer-Tropsch processes usually require pressures over 10 atm. Depending on the sulfur content of the methane source used in the methane 522 the conditioner 533 may also comprise a sulfur removal bed.

While the production of a synthetic hydrocarbon product 536 has been described above the conditioned syngas 534 could also be used as reduction gas for steel refining, to make methanol, to make alcohols, or to make aldehydes. Each alternative product may require syngas with a different hydrogen to carbon monoxide ratio, the throughput of the first reformer unit 523 and the reverse water-gas shift unit 531 may be altered to match the ratio needed.

The carbon product 538 produced will depend largely on the quality of the carbon 526 produced. If high quality carbons such as carbon nanotubes, graphene, graphite, or carbon black are produced the carbon processing unit 537 may include product separation, refining, and/or packaging of the carbon product 538. If the carbon 526 is not directly marketable as a high-end carbon product it could be used as biochar, reverse mined (buried) for carbon sequestration, or sequestered as carbon dioxide through enhanced oil and gas recovery (additional details on this use will be presented later).

### Example of the Fourth Embodiment: a System for the Chemical Production of Synthetic Hydrocarbon Products and Carbon with an Optimized Carbon Footprint

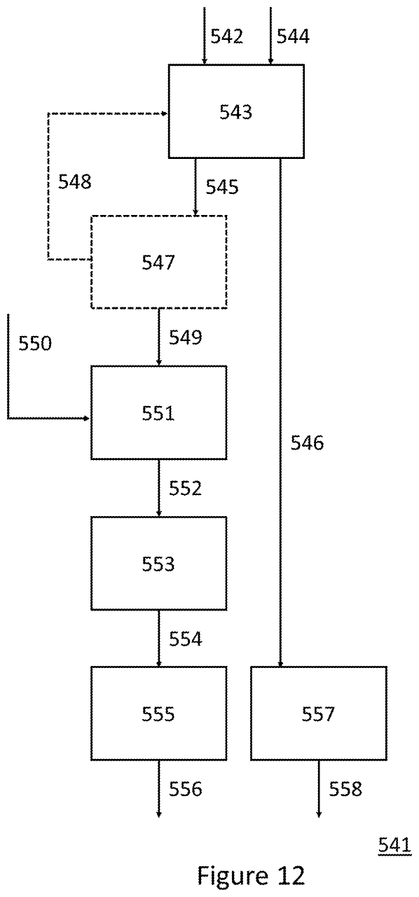

FIG. 12 gives a block diagram of a system for the chemical production of ammonia and carbon with an optimized carbon footprint according to the fourth embodiment 541. Methane 542 is fed into a first reformer unit 543 along with a first portion of electricity 544. The energy in the first portion of electricity 544 is used to drive the reformation (pyrolysis) of the methane 542 into hydrogen 545 and carbon 546.

The hydrogen 545 may flow into an optional hydrogen conditioner 547. In the optional hydrogen conditioner 547 any unwanted molecules (such as water, carbon dioxide, methane, sulfur-containing molecules) can be removed and the gas may be compressed, and/or an optional first recycling line 548 may be included to reinject a portion of the gases back into the first reformer unit 543. Gases not recycled to the first reformer unit 543 exit the optional hydrogen conditioner 547 as conditioned hydrogen 549. If the optional hydrogen conditioner 547 is not included the hydrogen 545 and the conditioned hydrogen 549 are equivalent.

The conditioned hydrogen 549 and air 550 flow into combustion reformer unit 551. In the combustion reformer unit 551 a portion of the conditioned hydrogen 549 and the oxygen within the air 550 are combusted reforming into water. A hydrogen and nitrogen-rich mixture 552, which will also contain at least water and small amounts of carbon dioxide (from within the air) exits the combustion reformer unit 551.

The hydrogen and nitrogen-rich mixture 552 flows into a conditioner 553. The conditioner 553 alters the properties (composition, temperature, pressure) of the gases to that which is required downstream. The conditioner 553 may use a vapor-liquid separator to remove the water produced by combustion and naturally present in the air 550. The conditioner 553 may also use amine scrubbing to remove the carbon dioxide. The conditioner 553 may also compress the gases, remove additional unwanted molecules (such as sulfur-containing molecules), and add additional molecules. Although not shown, a recycling line could also be included flowing from the conditioner 553 to the first reformer unit 543. A mixture 554 of conditioned nitrogen and hydrogen exit the conditioner 553.

The mixture 554 of conditioned nitrogen and hydrogen flows to a Haber-Bosch unit 555 where ammonia 556 is formed. Ammonia 556 production requires a hydrogen to nitrogen ratio of about 3. By separately controlling the throughput of the first reformer unit 543 and the air 550 to the combustion reformer unit 551, the hydrogen to nitrogen ratio can be tailored to the application. By driving the reforming process with at least a portion of the electricity made without emitting greenhouse gases the carbon footprint of the resultant ammonia 556 can be reduced as compared to the state-of-the-art.

Carbon 546, produced in the first reformer unit 543, is fed to a carbon processing unit 557 where carbon product 558 is formed. If needed, though not shown, a carbon conditioning unit could be included to prepare the carbon 546 for the carbon processing unit 557. The sale of the carbon product 558 may help offset the costs of the ammonia 556, making the price of the ammonia 556 which has a reduced carbon footprint more competitive with state-of-the-art ammonia products that do not have a reduced carbon footprint.

Preferably the first reformer unit 543 comprises a plasma-based reformer, such as, DC glow discharge, radio frequency discharge, arc discharge, corona discharge, dielectric barrier discharge, microwave discharge, AC discharge, or a gliding arc discharge. More preferably the first reformer unit 543 comprises a microwave discharge. The operating pressure of the first reformer unit 543 is preferably between 0.1 and 10 atm. More preferably the operating pressure of the first reformer unit 543 is between 0.95 and 5 atm.

Including the optional first recycling line 548 may help prevent solid carbon formation some regions off the first reformer unit 543. The inclusion of the optional first recycling line 548 may be especially useful in the preferred embodiment where the first reformer unit 543 comprises a plasma-based reformer. In such a reformer hydrogen gas from the optional first recycling line 548 could be used as a plasma gas within the plasma region of the reformer, and the methane 542 could be injected downstream from the plasma-region into the hot hydrogen gas to ensure carbon does not deposit within the plasma-region.

The conditioner 553 will likely comprise a compressor as Haber-Bosch processes usually require pressures around 200 atm. Depending on the sulfur content of the methane source used for methane 542 the conditioner 553 may also comprise a sulfur removal bed.

While the production of ammonia 556 has been described above additional processing steps may occur after the production of ammonia to form other products. Other possible products include urea, uric acid, ammonia hydroxide, and/or ammonium nitrate and other fertilizers.

The carbon product 558 produced will depend largely on the quality of the carbon 546 produced. If high quality carbons such as carbon nanotubes, graphene, graphite, or carbon black are produced the carbon processing unit 557 may include product separation, refining, and/or packaging of the carbon product 558. If the carbon 546 is not directly marketable as a high-end carbon product it could be used as biochar, reverse mined (buried) for carbon sequestration, or sequestered as carbon dioxide through enhanced oil and gas recovery (additional details on this use will be presented later).

### Embodiment 5

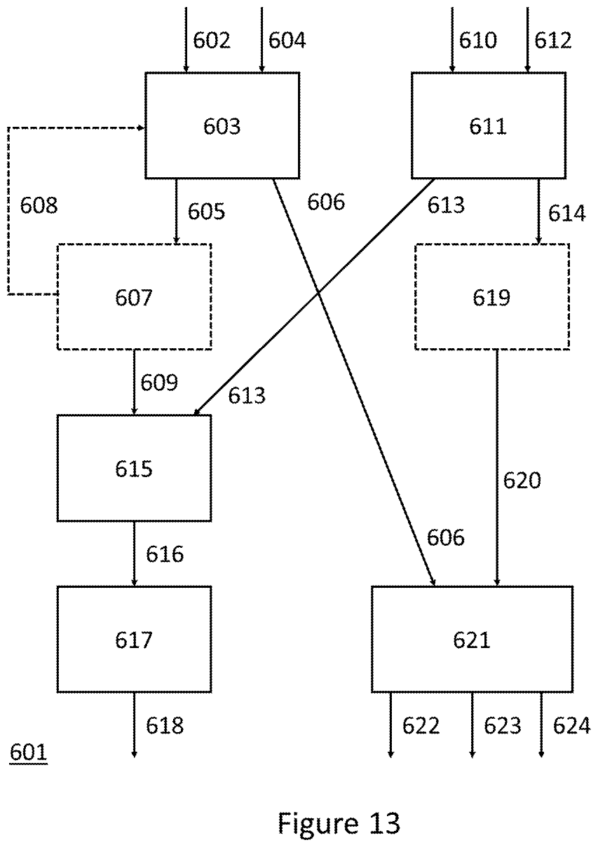

FIG. 13 gives a block diagram of a system for chemical production with an optimized carbon footprint according to the fifth embodiment 601. First reactants 602 are fed into a first reformer unit 603 along with a first portion of electricity 604. The energy in the first portion of electricity 604 is used to drive the reformation of the first reactants 602 into a first initial product 605 and a first secondary initial product 606. The first reformer unit 603 is configured to use the first portion of electricity 604 to molecularly alter the composition of the first reactants 602.

The first initial product 605 may flow into an optional first initial product conditioner 607. In the optional first initial product conditioner 607 unwanted molecules (such as water, carbon dioxide, sulfur-containing molecules) can be removed and the gases may be compressed, and/or an optional first recycling line 608 may be included to reinject a portion of the gases back into the first reformer unit 603. Gases not recycled to the first reformer unit 603 exit the optional first initial product conditioner 607 as a first conditioned initial product 609. If an optional first initial product conditioner 607 is not included the first initial product 605 and first conditioned initial product 609 are equivalent.

Second reactants 610 are fed into a second reformer unit 611 along with a second portion of electricity 612. The energy in the second portion of electricity 612 is used to drive the reformation of the second reactants 610 into a second initial product 613 and a second secondary initial product 614. The second reformer unit 611 is configured to use the second portion of electricity 612 to molecularly alter the composition of the second reactants 610.

The first conditioned initial product 609 and the second initial product 613 flow into a conditioner 615. The conditioner 615 alters the properties (composition, temperature, pressure) of the gases to that which is required downstream. The conditioner 615 mixes the first conditioned initial product 609 and the second initial product 613. The conditioner 615 may also compress the gases, remove unwanted molecules (such as water, carbon dioxide, sulfur-containing molecules), and add additional molecules. The amount of conditioning that must occur in the conditioner 615 depends partly on if the optional first initial product conditioner 607 was included. Although not shown, a recycling line could also be included flowing from the conditioner 615 to the first reformer unit 603, the second reformer unit 611, or both reformers. A conditioned intermediate product 616 exits the conditioner 615.

The conditioned intermediate product 616 flows to a processing unit 617 where a final chemical product 618 is formed. The processing unit 617 may be as simple as bottling or depositing the conditioned intermediate product 616 into a pipeline. The processing unit 617 may also include further molecule processing steps such as ammonia, urea, methanol, alcohols, and hydrocarbon formation or oil refining.

The second secondary initial product 614, produced in the second reformer unit 611, may flow into an optional second secondary product conditioner 619. In the optional second secondary product conditioner 619 unwanted molecules (such as water, sulfur-containing molecules) can be removed and the gases may be compressed. Conditioned second secondary product 620 exits the second secondary product conditioner 619. If an optional second secondary product conditioner 619 is not included the second secondary initial product 614 and the conditioned second secondary product 620 are equivalent.

First secondary initial product 606 and conditioned second secondary product 620 are flow into a third reformer unit 621. In the third reformer unit 621 the first secondary initial product 606 and the conditioned second secondary product 620 are reformed into a third primary product 622, a third secondary product 623, and a third tertiary product 624. Although not shown, if needed additional processing units could be included downstream of the third primary product 622, third secondary product 623, and/or third tertiary product 624 in order to form additional final products.

### Example of the Fifth Embodiment: a System for the Chemical Production of Ammonia, Carbon, Carbon Dioxide, and Electricity with an Optimized Carbon Footprint

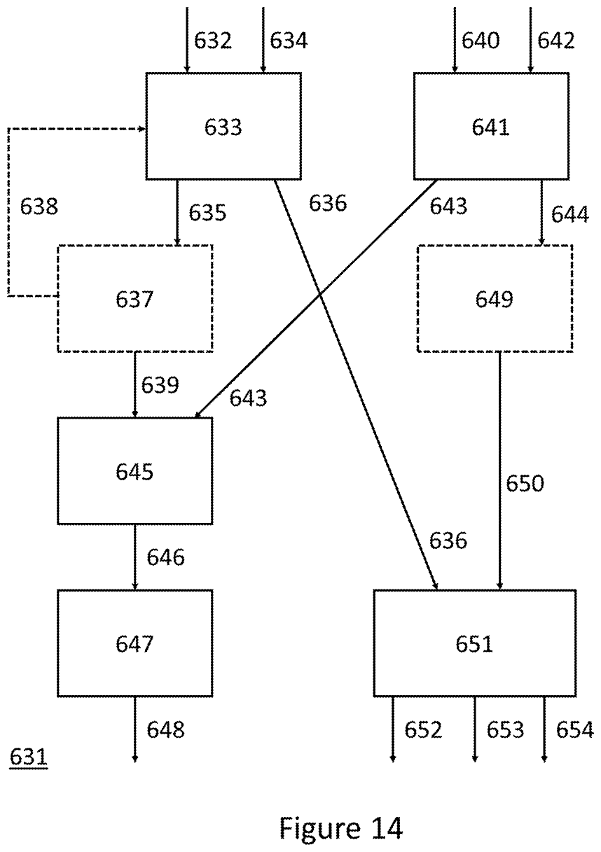

FIG. 14 gives a block diagram of a system for the chemical production of ammonia, carbon, carbon dioxide, and electricity with an optimized carbon footprint according to the fifth embodiment 631. Methane 632 is fed into a first reformer unit 633 along with a first portion of electricity 634. The energy in the first portion of electricity 634 is used to drive the reformation (pyrolysis) of the methane 632 into hydrogen 635 and carbon 636.

The hydrogen 635 may flow into an optional hydrogen conditioner 637. In the optional hydrogen conditioner 637 any unwanted molecules (such as water, carbon dioxide, methane, sulfur-containing molecules) can be removed and the gas may be compressed, and/or an optional first recycling line 638 may be included to reinject a portion of the gases back into the first reformer unit 633. Gases not recycled to the first reformer unit 633 exit the optional hydrogen conditioner 637 as conditioned hydrogen 639. If the optional hydrogen conditioner 637 is not included the hydrogen 635 and the conditioned hydrogen 639 are equivalent.

Air 640 is taken into an air separation unit 641 along with a second portion of electricity 642. The energy in the second portion of electricity 642 is used to drive the isolation of nitrogen from other gases in air, thus reforming the air 640 into a stream of nitrogen 643 and nitrogen-lean air 644 comprising primarily oxygen and carbon dioxide.

The conditioned hydrogen 639 and the nitrogen 643 flow into a conditioner 645. The conditioner 645 alters the properties (composition, temperature, pressure) of the gases to that which is required downstream. The conditioner 645 mixes the conditioned hydrogen 639 and the nitrogen 643. The conditioner 645 may also compress the gases, remove unwanted molecules (such as water, carbon dioxide, sulfur-containing molecules), and add additional molecules. A mixture 646 of conditioned nitrogen and hydrogen exits the conditioner 645.

The mixture 646 of conditioned nitrogen and hydrogen flows to a Haber-Bosch unit 647 where ammonia 648 is formed. Ammonia 648 production requires a hydrogen to nitrogen ratio of about 3. By separately controlling the throughput of the first reformer unit 633 and the air separation unit 641, the hydrogen to nitrogen ratio can be tailored to the application. By driving the reforming process with at least a portion of the electricity made without emitting greenhouse gases the carbon footprint of the resultant ammonia 648 can be reduced as compared to the state-of-the-art.

The nitrogen-lean air 644 comprising primarily oxygen and carbon dioxide, produced in the air separation unit 641, may flow into an optional oxygen and carbon dioxide conditioner 649. In the optional oxygen and carbon dioxide conditioner 649 unwanted molecules can be removed and the gases may be compressed. A mixture 650 of conditioned oxygen and carbon dioxide exits the optional oxygen and carbon dioxide conditioner 649. If an optional oxygen and carbon dioxide conditioner 649 is not included the nitrogen-lean air 644 comprising primarily oxygen and carbon dioxide and the mixture 650 of conditioned oxygen and carbon dioxide are equivalent.

Carbon 636, produced in the first reformer unit 633, and the mixture 650 of conditioned oxygen and carbon dioxide are fed to a combustion reformer unit 651. In the combustion reformer unit 651 a portion of the carbon 636 and the oxygen within the mixture 650 of conditioned oxygen and carbon dioxide are combusted reforming into carbon dioxide. Carbon dioxide 652 is the first product of the combustion reformer unit 651. The carbon dioxide 652 could be compressed and used for enhanced oil and gas recovery, alternatively, it could be used along with the ammonia 648 to produce urea. Carbon product 653 is the second product of the combustion reformer unit, as described in this example application for ammonia production. More carbon 636 will be produced than can be combusted with the oxygen in nitrogen-lean air 644 leading to a remaining carbon product 653. The third product of the combustion reformer unit 651 is generated electricity 654. The combustion of carbon and oxygen is highly exothermic, the heat produced can be used to boil water to turn steam turbines or the expanding hot carbon dioxide can be used to directly turn turbines producing generated electricity 654. This electricity 654 may be supplied to the first reformer unit 633, the air separation unit 641 or both.

Preferably the first reformer unit 633 comprises a plasma-based reformer, such as, DC glow discharge, radio frequency discharge, arc discharge, corona discharge, dielectric barrier discharge, microwave discharge, AC discharge, or a gliding arc discharge. More preferably the first reformer unit 633 comprises a microwave discharge. The operating pressure of the first reformer unit 633 is preferably between 0.1 and 10 atm. More preferably the operating pressure of the first reformer unit 633 is between 0.95 and 5 atm.

Including the optional first recycling line 638 may help prevent solid carbon formation in the first reformer unit 633. The inclusion of the optional first recycling line 638 may be especially useful in the preferred embodiment where the first reformer unit 633 is a plasma-based reformer. In such a reformer hydrogen gas from the optional first recycling line 638 could be used as a plasma gas within the plasma region of the reformer, and the methane 632 could be injected downstream from the plasma-region into the hot hydrogen gas to ensure carbon does not deposit within the plasma-region.

The conditioner 645 will likely comprise a compressor as Haber-Bosch processes usually require pressures around 200 atm.

Depending on the sulfur content of the methane source used for methane 632 the conditioner 645 may also comprise a sulfur removal bed. Further, depending on the requirements of the Haber-Bosch unit 647, water or carbon dioxide may need to be reduced as well using a vapor-liquid separator and/or amine scrubbing.

While the production of ammonia 648 has been described above additional processing steps may occur after the production of ammonia to form other products. Other possible products include urea (which as mentioned above could use the carbon dioxide 652), uric acid, ammonia hydroxide, and/or ammonium nitrate and other fertilizers.

The carbon product 653 produced will depend largely on the quality of the carbon 636 produced. High quality carbon products 653 include carbon nanotubes, graphene, graphite, and carbon black. Lower quality carbon products 653 include use as biochar, reverse mined (buried) for carbon sequestration, or sequestered as carbon dioxide through enhanced oil and gas recovery (additional details on this use will be presented later). If a spectrum of carbon 636 is produced lower value carbon could be combusted in the combustion reformer unit 651 while the higher value carbon could be used as the carbon product 653.

Use of carbon for enhanced oil and gas recovery

As mentioned in many of the embodiments, the carbon product from the various systems for chemical production may be used for enhanced oil and gas recovery by producing and sequestering carbon dioxide. In this section three example systems for using the carbon product to produce and sequester carbon dioxide while recovering oil and gas product are given.

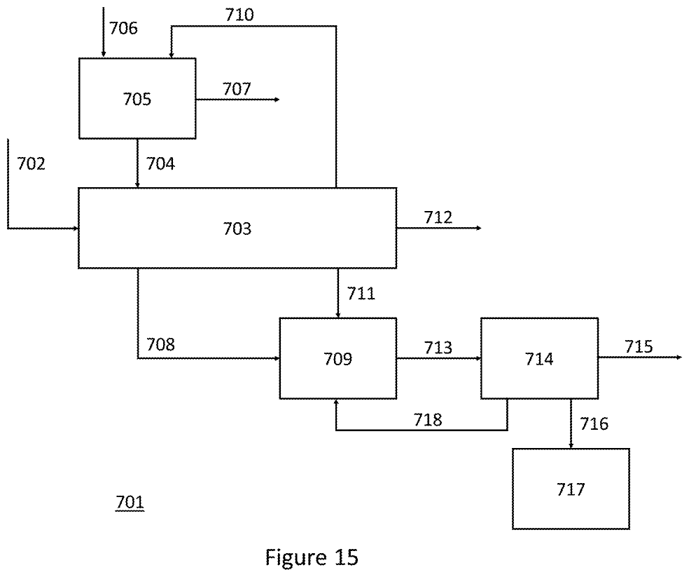

FIG. 15 gives a block diagram of a first example enhanced oil and gas recovery system using carbon product 701. Carbon product from upstream production 702 enters a combustion and power generation unit 703. Oxygen 704 from an air separation unit 705 also flows into the combustion and power generation unit 703. The oxygen 704 is taken from the air 706 processed in the air separation unit 705, oxygen poor air 707 from which the oxygen 704 is removed may be vented.

The carbon product from upstream production 702 and the oxygen 704 are combusted in the combustion and power generation unit 703 forming carbon dioxide 708. The carbon dioxide 708 flows to a compressor 709.

The combustion of carbon product from upstream production 702 and oxygen 704 in the combustion and power generation unit 703 produces heat which can be used to generate electricity directly by turning turbines with the carbon dioxide 708 or indirectly by producing steam that turns turbines. The electricity produced can include the electricity 710 for the air separation unit 705, the electricity 711 for the compressor 709, as well as additional electricity 712.

Pressurized carbon dioxide 713 exits the compressor 709 and flows to an oil and gas field 714. The pressurized carbon dioxide 713 aids in the recovery of oil and gas 715 from the oil and gas field 714. A portion of the carbon dioxide 716 becomes sequestered carbon dioxide 717, another portion of the carbon dioxide 718 is recovered from the oil and gas field 714 and returned for recompression in the compressor 709 prior to reinjection as pressurized carbon dioxide 713. The portion of the carbon dioxide 716 that becomes sequestered carbon dioxide 717 is generally around 90%.

Optionally, the combustion and power generation unit 703 can operate at a pressure greater that atmospheric. In this case the air separation unit 705 provides oxygen 704 at a pressure greater than atmospheric. The solid carbon product from upstream production 702 will also have to pressurized to the same level. Combusting the carbon product from upstream production 702 and oxygen 704 at a higher pressure will produce carbon dioxide 708 also having a pressure higher than atmospheric. Less electricity 711 for the compressor 709 will be required as the carbon dioxide 708 is already partly pressurized.

One benefit to this enhanced oil and gas recovery technique is the power production should be sufficient to drive carbon dioxide sequestration and oil and gas recovery, this may be vital for remote sites. For example, a system for the chemical production of hydrogen and carbon with an optimized carbon footprint according to the third embodiment 421 (FIG. 9) which is configured to produce 50 tonnes of hydrogen product 431 would produce about 6.3 tonnes of carbon product 433 every hour. The combustion of this 6.3 tonnes of carbon product from upstream production 702 (FIG. 15) requires 16.7 tonnes of oxygen 704 and produces 23 tonnes of carbon dioxide 708 every hour. Approximately 8 MW of electricity would be generated by combustion, about 4 MW of electricity are required for electricity 710 for the air separation unit 705 and the other 4 MW of electricity are required as electricity 711 for the compressor 709. Thus, the combustion of carbon should generate enough electricity to drive the sequestration of carbon dioxide 717 and oil and gas 715 recovery. This example assumed the air separation unit 705 was used to produce pure oxygen 704. However, if less pure oxygen 704 can be used the air separation unit 705 will not require as much electricity 710. An air separation unit 705 producing oxygen 704 of 95% concentration will require about 1 MW less electricity 710 per hour, in this case additional electricity 712 is produced.

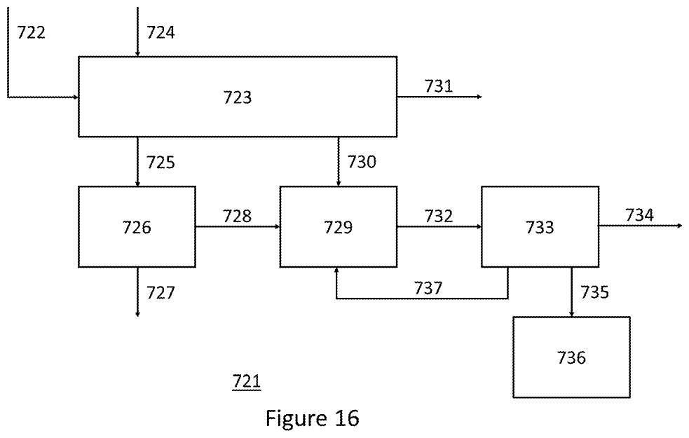

FIG. 16 gives a block diagram of a second example enhanced oil and gas recovery system using carbon product 721. Carbon product from upstream production 722 enters a combustion and power generation unit 723. Air 724 is driven into the combustion and power generation unit 723. The carbon product from upstream production 722 and the air 724 are combusted in the combustion and power generation unit 723 forming a carbon dioxide-rich gas 725. The carbon dioxide-rich gas 725 exits the combustion and power generation unit 723 and flows into amine scrubber unit 726.

The amine scrubber unit 726 separates the carbon dioxide-rich gas 725 into a stream of primarily nitrogen gas 727 which can be vented and carbon dioxide 728. The carbon dioxide 728 flows to a compressor 729.

The combustion of carbon product from upstream production 722 and air 724 in the combustion and power generation unit 723 produces heat which can be used to generate electricity directly by turning turbines with the carbon dioxide-rich gas 725 or indirectly by producing steam that turns turbines. The electricity produced can include the electricity 730 for the compressor 729, as well as additional electricity 731.

Pressurized carbon dioxide 732 exits the compressor 729 and flows to an oil and gas field 733. The pressurized carbon dioxide 732 aids in the recovery of oil and gas 734 from the oil and gas field 733. A portion of the carbon dioxide 735 becomes sequestered carbon dioxide 736, another portion of the carbon dioxide 737 is recovered from the oil and gas field 733 and returned for recompression in the compressor 729 prior to reinjection as pressurized carbon dioxide 732. The portion of the carbon dioxide 735 that becomes sequestered carbon dioxide 736 is generally around 90%.

One benefit to this enhanced oil and gas recovery technique is the power production should be sufficient to drive carbon dioxide sequestration and oil and gas recovery, this may be vital for remote sites. For example, a system for the chemical production of hydrogen and carbon with an optimized carbon footprint according to the third embodiment 421 (FIG. 9) which is configured to produce 50 tonnes of hydrogen product 431 would produce about 6.3 tonnes of carbon product 433 every hour. The combustion of this 6.3 tonnes of carbon product from upstream production 722 (FIG. 16) requires about 72 tonnes of air 724 and produces about 78 tonnes of carbon dioxide-rich gas 725 every hour. Approximately 7.5 MW of electricity would be generated by combustion, about 4.7 MW of electricity 730 are required as electricity for the compressor 729. Thus, the combustion of carbon should generate enough electricity to drive the sequestration of carbon dioxide 736 and oil and gas 734 recovery. This example assumed the amine scrubber unit 726 produces 95% carbon dioxide 728 (about 24 tonnes per hour). The additional electricity 731 should be enough to drive air 724 into the combustion and power generation unit 723, and the pumps and boiler in the amine scrubber unit 726.

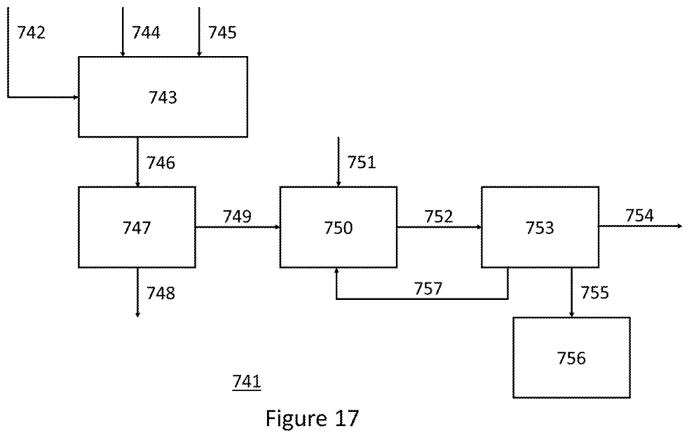

FIG. 17 gives a block diagram of a third example enhanced oil and gas recovery system using carbon product 741. Carbon product from upstream production 742 enters a heater unit 743. Water 744 also flows into the heater unit 743. Within the heater unit 743 the carbon product from upstream production 742 and water 744 are mixed into a slurry and heated using electricity 745 to a temperature greater than 600° C. At these temperatures, reformation of the carbon product from upstream production 742 and water 744 into a gas 746 with hydrogen and carbon dioxide takes place.

The gas 746 with hydrogen and carbon dioxide flow into a separation unit 747 (such as a pressure swing absorber unit or a membrane separator), here hydrogen product 748 is separated from carbon dioxide 749. The hydrogen product 748 can be used as is or further processed into other chemicals (as discussed above). Carbon dioxide 749 flows out of the separation unit 747 into a compressor 750.

The compressor 750 uses electricity 751 to compress the carbon dioxide 749, and pressurized carbon dioxide 752 exits the compressor 750. The pressurized carbon dioxide 752 flows to an oil and gas field 753. The pressurized carbon dioxide 752 aids in the recovery of oil and gas 754 from the oil and gas field 753. A portion of the carbon dioxide 755 becomes sequestered carbon dioxide 756, another portion of the carbon dioxide 757 is recovered from the oil and gas field 753 and returned for recompression in the compressor 750 prior to reinjection as pressurized carbon dioxide 752. The portion of the carbon dioxide 755 that becomes sequestered carbon dioxide 756 is generally around 90%.

Unlike the other two example oil and gas recovery applications, this example would require access to electricity 745 for the heater unit 743 and electricity 751 for the compressor 750. However, this example also forms hydrogen product 748, in addition to sequestered carbon dioxide 756 and oil and gas 754.

1. A system for the production of chemical products having an optimized carbon footprint, comprising:
a first reformer unit which receives first reactants, receives a first portion of electricity, and produces a first initial product;
a conditioner which receives the first initial product or a first conditioned initial product and produces a conditioned intermediate product;
and a processing unit which receives the conditioned intermediate product and produces a final chemical product;
wherein the first reformer unit is configured to use the first portion of electricity to molecularly alter the composition of the first reactants into the first initial product.

2. The system for the production of chemical products having an optimized carbon footprint of claim 1, further comprising:
a second reformer unit which receives second reactants, and produces a second initial product;
wherein the second reactants and the second initial product have molecularly different compositions.

3. The system for the production of chemical products having an optimized carbon footprint of claim 2, wherein the second reformer unit further receives a second portion of electricity;
wherein said second reformer unit is configured to use said second portion of electricity to molecularly alter the composition of the second reactants into the second initial product.

4. The system for the production of chemical products having an optimized carbon footprint of claim 1, wherein
said first reformer unit additionally produces a first secondary initial product.

5. The system for the production of chemical products having an optimized carbon footprint of claim 3, wherein
said second reformer unit additionally produces a second secondary initial product.

6. The system for the production of chemical products having an optimized carbon footprint of claim 5, wherein
said first reformer unit additionally produces a first secondary initial product.

7. The system for the production of chemical products having an optimized carbon footprint of claim 3, wherein
said first reformer unit comprises a first plasma-based reformer;
said second reformer unit comprises a second plasma-based reformer;
and said second initial product or a second conditioned initial product is also received by said conditioner.

8. The system for the production of chemical products having an optimized carbon footprint of claim 7, wherein
said first plasma-based reformer is a microwave reformer;
and said second plasma-based reformer is a microwave reformer.

9. The system for the production of chemical products having an optimized carbon footprint of claim 8, further comprising:
a first initial product conditioner between said first reformer unit and said conditioner that receives the first initial product and generates the first conditioned initial product;
wherein a portion is removed from the first conditioned initial product and reinjected into the first reformer unit.

10. The system for the production of chemical products having an optimized carbon footprint of claim 9, further comprising:
a second initial product conditioner between said second reformer unit and said conditioner that receives the second initial product and generates the second conditioned initial product;
wherein a portion is removed from the second conditioned initial product and reinjected into the second reformer unit.

11. The system for the production of chemical products having an optimized carbon footprint of claim 8, wherein
said first reactants comprise water and methane;
said second reactants comprise carbon dioxide and methane;
said processing unit comprises a Fischer-Tropsch unit;
and said final chemical product comprises synthetic hydrocarbons.

12. The system for the production of chemical products having an optimized carbon footprint of claim 5, further comprising:
a secondary product processing unit which receives the second secondary initial product from the second reformer unit and produces a secondary final chemical product;
wherein said second initial product or a second conditioned initial product is also received by said conditioner.

13. The system for the production of chemical products having an optimized carbon footprint of claim 12, further comprising:
a first initial product conditioner between said first reformer unit and said conditioner that receives the first initial product and generates the first conditioned initial product;
wherein a portion is removed from the first conditioned initial product and reinjected into the first reformer unit.

14. The system for the production of chemical products having an optimized carbon footprint of claim 12, further comprising:
a second initial product conditioner between said second reformer unit and said conditioner that receives the second initial product and generates the second conditioned initial product;
wherein a portion is removed from the second conditioned initial product and reinjected into the second reformer unit.

15. The system for the production of chemical products having an optimized carbon footprint of claim 13, further comprising:
a second initial product conditioner between said second reformer unit and said conditioner that receives the second initial product and generates the second conditioned initial product;
wherein a portion is removed from the second conditioned initial product and reinjected into the second reformer unit.

16. The system for the production of chemical products having an optimized carbon footprint of claim 12, wherein
said first reformer unit comprises a first plasma-based reformer.

17. The system for the production of chemical products having an optimized carbon footprint of claim 16, wherein
said first plasma-based reformer is a microwave reformer.

18. The system for the production of chemical products having an optimized carbon footprint of claim 17, wherein
said second reformer unit comprises an electrolysis reformer;
said first reactants comprise carbon dioxide and methane;
said second reactants comprise water;
said processing unit comprises a Fischer-Tropsch unit;
said final chemical product comprises synthetic hydrocarbons;
and said secondary final chemical product comprises oxygen.

19. The system for the production of chemical products having an optimized carbon footprint of claim 17, wherein
said second reformer unit comprises a microwave reformer;
said first reactants comprise carbon dioxide and methane;
said second reactants comprise methane;
said processing unit comprises a Fischer-Tropsch unit;
said final chemical product comprises synthetic hydrocarbons;
and said secondary final chemical product comprises carbon.

20. The system for the production of chemical products having an optimized carbon footprint of claim 12, wherein
said first reformer unit comprises an air separation unit;
said second reformer unit comprises a microwave reformer;
said first reactants comprise air;
said second reactants comprise methane;
said processing unit comprises a Haber-Bosch unit;
said the final chemical product comprises ammonia;
and said secondary final chemical product comprises carbon.

21. The system for the production of chemical products having an optimized carbon footprint of claim 4, wherein
a portion is removed from the first conditioned initial product and reinjected into the first reformer unit.

22. The system for the production of chemical products having an optimized carbon footprint of claim 21, wherein
said first reformer unit comprises a microwave reformer;
said first reactants comprise methane;
said processing unit comprises a hydrogen processing unit;
said final chemical product comprises hydrogen;
and said secondary final chemical product comprises carbon.

23. The system for the production of chemical products having an optimized carbon footprint of claim 4, further comprising:
a secondary product processing unit which receives said first secondary initial product and produces a secondary final chemical product;
second reformer unit which receives second reactants, said first initial product or a first conditioned initial product, and produces a second initial product;
wherein the second reactants and the second initial product have molecularly different compositions.

24. The system for the production of chemical products having an optimized carbon footprint of claim 23, further comprising:
a first initial product conditioner between said first reformer unit and said second reformer unit that receives the first initial product and generates the first conditioned initial product;
wherein a portion is removed from the first conditioned initial product and reinjected into the first reformer unit.

25. The system for the production of chemical products having an optimized carbon footprint of claim 24, wherein
said first reformer unit comprises a first plasma-based reformer.

26. The system for the production of chemical products having an optimized carbon footprint of claim 25, wherein
said first plasma-based reformer is a microwave reformer.

27. The system for the production of chemical products having an optimized carbon footprint of claim 26, wherein
said second reformer unit comprises a reverse water-gas shift reactor;
said first reactants comprise methane;
said second reactant comprise carbon dioxide;
said processing unit comprises a Fischer-Tropsch unit;
said final chemical product comprises synthetic hydrocarbons;
and said secondary final chemical product comprises carbon.

28. The system for the production of chemical products having an optimized carbon footprint of claim 26, wherein
said second reformer unit comprises a combustion reformer;
said first reactants comprise methane;
said second reactant comprise air;
said processing unit comprises a Haber-Bosch unit;
said final chemical product comprises ammonia;
and said secondary final chemical product comprises carbon.

29. The system for the production of chemical products having an optimized carbon footprint of claim 6, wherein
said first reformer unit comprises a first microwave reformer.

30. The system for the production of chemical products having an optimized carbon footprint of claim 29, further comprising:
a first initial product conditioner between said first reformer unit and said conditioner that receives the first initial product and generates the first conditioned initial product;
wherein a portion is removed from the first conditioned initial product and reinjected into the first reformer unit.

31. The system for the production of chemical products having an optimized carbon footprint of claim 29, wherein
said second reformer unit comprises an air separation unit;
said first reactants comprise methane;
said second reactants comprise air;
said first initial product of the first reformer unit comprises hydrogen;
said first secondary initial product of the first reformer unit comprises carbon;
said second initial product of the second reformer unit comprises nitrogen;
said second secondary initial product of the second reformer unit comprises nitrogen-lean air;
said processing unit comprises a Haber-Bosch unit;
said final chemical product comprises ammonia;
and said secondary final chemical product comprises carbon.

32. The system for the production of chemical products having an optimized carbon footprint of claim 4, further comprising
an enhanced oil and gas recovery unit;
wherein said first secondary initial product comprises carbon;
and wherein the first secondary initial product is turned into carbon dioxide which is sequestered underground via enhanced oil and gas recovery within the enhanced oil and gas recovery unit.

33. The system for the production of chemical products having an optimized carbon footprint of claim 5, further comprising
an enhanced oil and gas recovery unit;
wherein said second secondary initial product comprises carbon;
and wherein the second secondary initial product is turned into carbon dioxide which is sequestered underground via enhanced oil and gas recovery within the enhanced oil and gas recovery unit.

34. The system for the production of chemical products having an optimized carbon footprint of claim 32, wherein
the enhanced oil and gas recovery unit comprises a combustion and power generation unit.

35. The system for the production of chemical products having an optimized carbon footprint of claim 33, wherein
the enhanced oil and gas recovery unit comprises a combustion and power generation unit.

36. The system for the production of chemical products having an optimized carbon footprint of claim 34, wherein
the enhanced oil and gas recovery unit further comprises an air separation unit.

37. The system for the production of chemical products having an optimized carbon footprint of claim 35, wherein
the enhanced oil and gas recovery unit further comprises an air separation unit.

38. The system for the production of chemical products having an optimized carbon footprint of claim 34, wherein
the enhanced oil and gas recovery unit further comprises an amine scrubber unit.

39. The system for the production of chemical products having an optimized carbon footprint of claim 35, wherein
the enhanced oil and gas recovery unit further comprises an amine scrubber unit.

40. The system for the production of chemical products having an optimized carbon footprint of claim 32, wherein
the enhanced oil and gas recovery unit comprises a heater unit which produces hydrogen.

41. The system for the production of chemical products having an optimized carbon footprint of claim 33, wherein
the enhanced oil and gas recovery unit comprises a heater unit which produces hydrogen.
